(19) United States
(12) Patent Application Publication
(10) Pub. No.: US 2018/0188898 A1
(43) Pub. Date: Jul. 5, 2018

(54) USER INTERFACES WITH SEMANTIC TIME ANCHORS

(71) Applicant: Intel Corporation, Santa Clara, CA (US)

(72) Inventors: OMRI MENDELS, Tel Aviv (IL); MICHAL WOSK, Tel Aviv (IL); OR RON, Tel Aviv (IL); MERAV GREENFELD, Ness Ziona (IL); GILI ILAN, Hertzeliya (IL); RONEN VENTURA, Modiin (IL)

(21) Appl. No.: 15/394,754

(22) Filed: Dec. 29, 2016

(51) Int. Cl. G06F 3/0482; G06F 3/0488; G06F 17/27; G06F 3/0486

(52) U.S. Cl. CPC G06F 3/0482; G06F 3/0486; G06F 17/2785; G06F 3/0488

(57) ABSTRACT

Disclosed methods, systems, and storage media provide state-based time/task management interfaces. A computer device may determine various user states and user intents, and generate an instance of a graphical user interface (GUI) comprising objects and semantic time anchors. Each object may correspond to a user intent and each semantic time anchor may be associated with a user state. The computer device may obtain a first input comprising a selection of an object and obtain a second input comprising a selection of a semantic time anchor. The computer device may generate another instance of the GUI to indicate an association of the selected object with the selected semantic time anchor. The computer device may generate a notification to indicate a user intent of the selected object upon occurrence of a state that corresponds with the selected semantic time anchor. Other embodiments may be described and/or claimed.

### FIELD

The present disclosure relates to the field of computing graphical user interface, and in particular, to apparatuses, methods and storage media for displaying user interfaces to create and manage optimal day routes for users.

### BACKGROUND

The day-to-day lives of individuals may include a variety of “intents,” which may be user actions or states. Intents may include places to be, tasks to complete, calls to make, meetings to attend, commutes and travel to conduct, workouts to complete, friends to meet, and so forth. Some intents may be considered “needs” and other intents may be considered “wants.” Intents may be tracked and/or organized using time management applications, which may include calendars, task managers, contact managers, etc. These conventional time management applications use time-based interfaces, which may only allow a user to define tasks and assign time and dates to those tasks. However, in many cases intents may be dependent on one another and/or dependent upon a user's state. Therefore, intent fulfillment, time, and location may influence the timing and locations of other intents. Conventional time management applications do not account for the interdependence between user intents.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates components and interaction points in which various example embodiments described in the present disclosure may be implemented;

FIG. 2 illustrates an example of a list of intents and a list of candidate intents in accordance with various example embodiments;

FIG. 3 illustrates the components of a computer device in accordance with various example embodiments;

FIGS. 4-7 illustrate various example graphical user interfaces (GUIs) rendered in a touchscreen, in accordance with various embodiments;

FIGS. 8-9 illustrate an example GUI rendered in computer display, in accordance with various embodiments;

FIG. 10 illustrates example GUIs rendered in touchscreen, in accordance with various other embodiments;

FIG. 11 illustrates an example process for determining user states and generating a list of intents, in accordance with various embodiments;

FIG. 12 illustrates an example process for generating various GUI instances, in accordance with various embodiments;

FIG. 13 illustrates an example process for generating and issuing notifications, in accordance with various embodiments; and

FIG. 14 illustrates an example computer-readable media, in accordance with various example embodiments.

### DETAILED DESCRIPTION

Example embodiments are directed to state-based time management user interfaces (UIs). In embodiments, a UI may allow a user to organize his/her intents in relation with other intents, actions, and/or events, and an application may automatically determine the influence of the intents on one another and adjust the UI accordingly.

Typical time-management UIs (e.g., calendars or task lists) are time-based, wherein tasks or events are scheduled according to date and/or time of day. By contrast, various embodiments provide for the organization of tasks or events based on a computer device's state. In embodiments, a computer device may determine a state and user actions to be performed (also referred to as “intents”). A state may be a current condition or mode of operation of the computer device, such as moving at a particular velocity, arriving at a particular location (e.g., geolocation or a location within a building, etc.), using a particular application, etc. States may be determined using information from a plurality of sources (e.g., GPS, sensor data, application data mining, online sources, estimated by Wi-Fi or Cell tower, sensors (activity), typing/receiving text messages, emails, etc.). A user action to be performed may be any type of action, task, or event to take place, such as approaching and/or arriving at a particular location, a particular task to be performed, a particular task to be performed with one or more particular participants, being late or early to a particular event, etc. The actions may be derived from the same or similar sources discussed previously, derived from user routines/habits, or they may be explicitly input by the user of the computer device.

In embodiments, the UI may include a plurality of semantic time anchors and a list of actions to be performed (hereinafter, may simply be referred to as “action”). The user may use graphical control elements to associate the listed actions with one or more anchors (e.g., drag and drop action onto a semantic time anchor). The semantic time anchors are based on “semantic times” that are not solely determined by the time of day, but rather by the state and other contextual factors. For example, when a user sets a reminder for “when I leave work”, this semantic time is not associated with a specific time of day but rather to the detection of the user's computer device moving away from a geolocation associated with “work”.

In the following detailed description, reference is made to the accompanying drawings which form a part hereof wherein like numerals designate like parts throughout, and in which is shown by way of illustrated embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed to imply that the various operations are necessarily order-dependent. In particular, these operations might not be performed in the order of presentation. Operations described may be performed in a different order than the described embodiments. Various additional operations might be performed, or described operations might be omitted in additional embodiments.

The description may use the phrases “in an embodiment”, “in an implementation”, or in “embodiments” or “implementations”, which may each refer to one or more of the same or different embodiments. Furthermore, the terms “comprising,” “including,” “having,” and the like, as used with respect to embodiments of the present disclosure, are synonymous.

Also, it is noted that example embodiments may be described as a process depicted with a flowchart, a flow diagram, a data flow diagram, a structure diagram, or a block diagram. Although a flowchart may describe the operations as a sequential process, many of the operations may be performed in parallel, concurrently, or simultaneously. In addition, the order of the operations may be re-arranged. A process may be terminated when its operations are completed, but may also have additional steps not included in a figure. A process may correspond to a method, a function, a procedure, a subroutine, a subprogram, and the like. When a process corresponds to a function, its termination may correspond to a return of the function to the calling function a main function.

As disclosed herein, the term “memory” may represent one or more hardware devices for storing data, including random access memory (RAM), magnetic RAM, core memory, read only memory (ROM), magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

As used herein, the term “circuitry” refers to, is part of, or includes hardware components such as an Application Specific Integrated Circuit (ASIC), a field-programmable gate array (FPGA), programmable logic arrays (PLAs), complex programmable logic devices (CPLDs), one or more electronic circuits, one or more logic circuits, one or more processors (shared, dedicated, or group) and/or memory (shared, dedicated, or group) that are configured to provide the described functionality. In some embodiments, the circuitry may execute computer-executable instructions to provide at least some of the described functionality. The computer-executable instructions may represent program code or code segments, software or software logics, firmware, middleware or microcode, procedures, functions, subprograms, routines, subroutines, one or more software packages, classes, or any combination of instructions, data structures, program statements, and/or functional processes that perform particular tasks or implement particular data types. The computer-executable instructions discussed herein may be implemented using existing hardware in computer devices and communications networks.

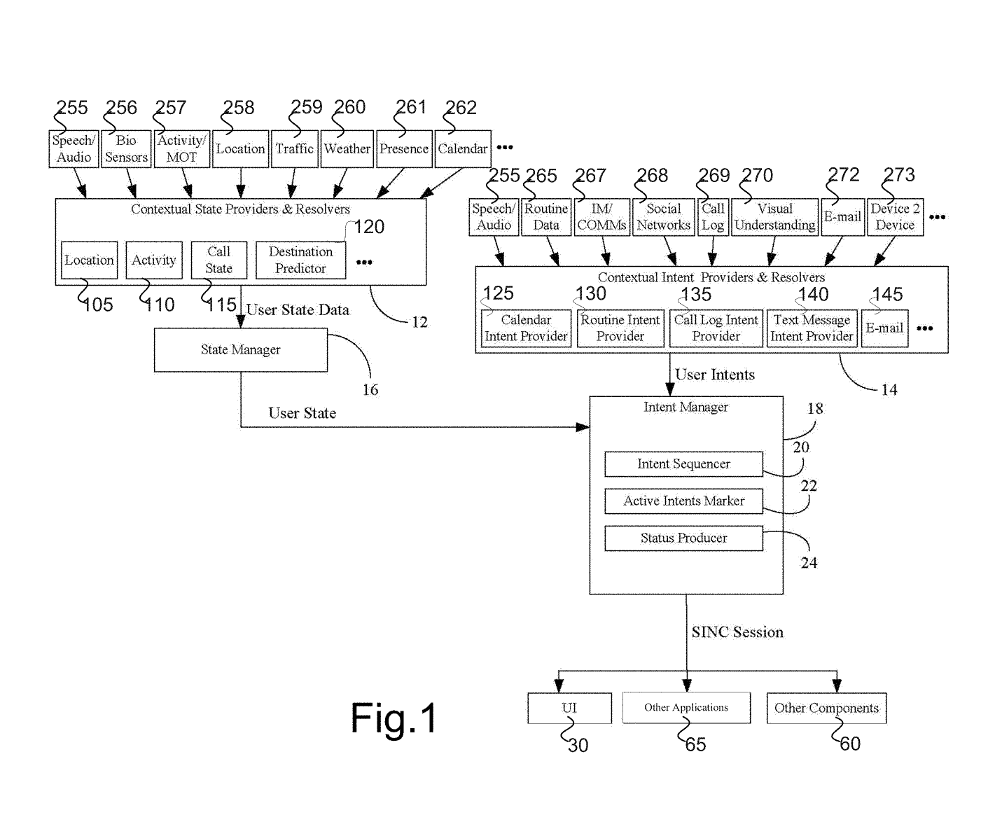

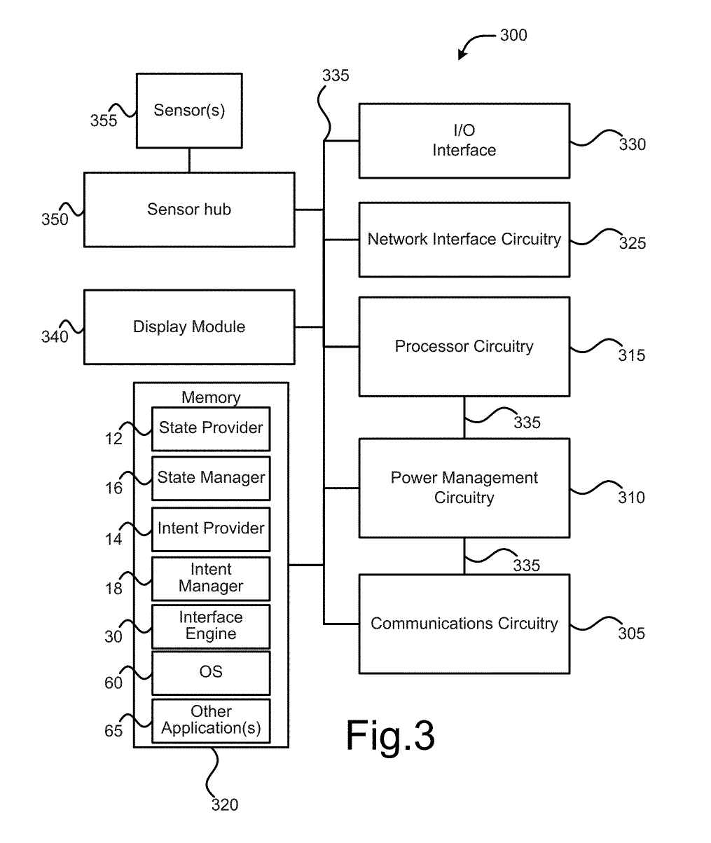

Referring now to the figures. FIG. 1 illustrates components and interaction points in which various example embodiments described in the present disclosure may be implemented. In various embodiments, the components shown and described by FIG. 1 may be implemented using a computer device 300, which is shown and described with regard to FIG. 3.

In embodiments, the state providers 12 may include location logic 105, activity logic 110, call state logic 115, and destination predictor logic 120 (collectively referred to as “state providers” or “state providers 12”). These elements may be capable of monitoring and tracking corresponding changes in the user state. For example, location logic 105 may monitor and track a location (e.g., geolocation, etc.) and/or position of the computer device 300; activity logic 110 may monitor and track an activity state of the computer device 300, such as whether the user is driving, walking, or is stationary; call state logic 115 may monitor and track whether the computer device 300 is making a phone call (e.g., cellular, voice over IP (VoIP), etc.) or sending/receiving messages (e.g., Short Messaging Service (SMS) messages, messages associated with a specific application, etc.). The destination predictor logic 120 may determine or predict a user's location based on the other state providers 12 and/or any other contextual or state information. The state provider(s) 12 may utilize drivers and/or application programming interfaces (APIs) to obtain data from other applications, components, or sensors. In embodiments, the state provider(s) 12 may use the data obtained from the other applications/components/sensors to monitor and track their corresponding user states. Such applications/components/sensors may include speech/audio sensors 255, biometric sensors 256, activity tracking and/or means of transport (MOT) applications 257, location or positioning sensors 258, traffic applications 259, weather applications 260, presences or proximity sensors 261, and calendar applications 262. Any other contextual state that can be inferred from existing or future applications, components, sensors, etc. may be used as a state provider 12.

The state provider 12 may provide state information to the state manager 16. The state manager 16 may collect the data provided by one or more of the state providers 12, and generate a “user state entity” from such data. The user state entity may represent the user's current contextual state description that is later used by the intent manager 18. To generate the user state entity, the state manager 16 may determine one or more contextual factors associated with each of the states based on location data from location or positioning sensors 258, sensor data from speech/audio sensors 255 and/or bio-sensors 256, and/or application data from one or more applications implemented by the computer device 300. In embodiments, the one or more contextual factors may include an amount of time that the computer device 300 is at a particular location, an arrival time at a particular location, a departure time from a particular location, a distance traveled between two or more locations, a travel velocity of the computer device 300, position and orientation changes of the computer device 300, media settings of the computer device 300, information contained in one or more messages sent by the computer device 300, information contained in one or more messages received by the computer device 300, and/or other like contextual factors. Whenever the state manager 16 recognizes a change in the user state, the state manager 16 may trigger an event of “user state changed”, which can later lead to recalculation of the user's day including generating a new instant of a UI (discussed infra).

Intent providers 14 (also referred to as “contextual intent providers and resolvers 14”) may monitor and track user intents based on various applications and/or components of the computer device 300. In embodiments, the intent providers 14 may include calendar intent provider 125, routine intent provider 130, call log intent provider 135, text message intent provider 140, e-mails intent provider 145, and/or any other providers that can infer or determine intents from existing or future modules/applications, sensors, or other devices. Each of the intent providers 14 may be in charge of monitoring and tracking changes of a corresponding user intent. For example, the calendar intent provider 125 may monitor and track changes in scheduled tasks or events; the routine intent provider 130 may monitor and track changes in the user's routine (e.g., daily, weekly, monthly, yearly, etc.); the call log intent provider 135 may monitor and track changes in phone calls received/sent by the computer device 300 (e.g., phone numbers or other identifiers (International Mobile Subscriber Identity (IMSI), Mobile Station International Subscriber Directory Number (MSISDN), etc.) that call or are called by the computer device 300, content of the calls, and duration of the calls, etc.); text message intent provider 140 may monitor and track changes in text messages received/sent by the computer device 300 (e.g., identifiers (IMSI, MSISDN, etc.) of devices sending/receiving messages to/from the computer device 300, content of the messages, etc.); and the e-mails intent provider 145 may monitor and track changes in may monitor and track changes in text messages received/sent by the computer device 300 (e.g., identifiers (e-mail addresses, IP addresses, etc.) of devices sending/receiving e-mails to/from the computer device 300, content of the messages, time e-mails are sent, etc.). The intent provider(s) 14 may utilize drivers and/or APIs to obtain data from other applications, components, or sensors. In embodiments, the intent provider(s) 14 may use the data obtain from the other applications/components/sensors to monitor and track their corresponding user intents. Such applications/components/sensors may include speech/audio sensors 255; routine data 265 (e.g., from calendar applications, task managers, etc.); instant message or other communications 267 from associated applications; social networking applications 268, call log 269, visual understanding 270, e-mail applications 272, and data obtained during device-to-device (D2D) communications 273. Any other data/information that can be inferred from existing or future sensors or devices may be used by the intent providers 14. The intent provider 14 may provide intent information to the intent manager 18.

The intent manager 18 may implement the intent sequencer 20, active intents marker 22, and status producer 24. The intent sequencer 20 may receive intents from the various intent providers 14, order the various intents, and identify conflicts between the various intents. The active intents marker 22 may receive the sequence of intents produced by the intent sequencer 20, and identify/determine if any of the intents are currently active using the user state received from the state manager 16. The status producer 24 may receive the sequence of intents with the active intents marked by the active intents marker 22, and determine the status of each intent with regard to the user state received by the state manager 16. The output of the intent manager 18 may be a State Intent Nerve Center (SINC) session object that is displayed to users in a user interface (discussed infra), and is also used by additional components in the system. In embodiments, whenever the intent manager 18 recognizes a change in the user intents, the intent manager 18 may trigger re-execution of the above three phases and generate a new SINC session object. In embodiments, whenever the state manager 16 triggers a “user state changed” event, the intent manager 18 may trigger a re-execution of the three phases and generate the new SINC session object. In some embodiments, the state manager 16 may mark timestamps in which SINC session object generate is due, which may be based on its understanding of the current day and in addition to or alternative to external triggers. For example, when the intent manager 18 identifies that a meeting is about to end in ten minutes, the intent manager 18 may set SINC session object generation/recalculation to occur in ten minutes. Generation of the new SINC session object may cause a change in the entire day and generation of new instances of the UI.

In embodiments, the intent sequencer 20 may first perform grouping operations, which may include dividing the intents it receives from the intent providers 14 into three types of intents: “time and location intents,” “time only intents,” and “unanchored intents.” The intent sequencer 20 may then perform sequencing operations, which may include using the “time & location intents” to generate a graph or other like representation of data indicating routes or connections between the intents. In embodiments, the intent sequencer 20 may generate a directed weighted non-cyclic graph (also referred to as a “directed acyclic graph”) that includes a minimal collection of routes that cover a maximum number of intents. This may be done using a routing algorithm such as, for example, a “Minimum Paths, Maximum Intents” (MPMI) solution.

Next, the intent sequencer 20 may perform anchoring operations, which may include selecting intents from the “unanchored intents” group and selecting that depend on moving between points, such as, but not limited to: arrive to a location intents, leave location intents, on the way to a location intents, on the next drive intents, on the next walk intents, and the like. The intent sequencer 20 may then try to anchor the selected intents onto vertices or edges on the graph that was generated in the sequencing phase. Next, the intent sequencer 20 may perform conflicts identification, which may include iterating on the graph to identify intent conflicts. A conflict may be a case in which there are two intents that do not have any route between them. The intent sequencer 20 may indicate the existence of an intent conflict by, for example, marking the conflicts on the graph. Next, the intent sequencer 20 may perform projection operations where each intent in the graph is paired with a physical time so that the intents on the graph may be ordered according to their timing. Finally, the intent sequencer 20 may perform completion operations where the group of “time only intents” may be added to the resulting graph according to their timing so that a full timeline with all intents that can be anchored is generated.

The active intents marker 22 may receive the output graph from the intent sequencer 20, and may apply a set of predefined rules on each intent in order to determine whether the user is engaged in a particular intent at a particular moment based on the intents graph and user state data from the state manager 16. These rules may be specific for each intent type on the graph. For example, for a meeting intent in the graph, the active intents marker 22 may determine whether the current time is the time of the meeting, and if the current user location is the location of the meeting. If both parameters are positive, then the active intents marker 22 may mark the meeting intent as active or ongoing.

The status producer 24 may receive the intents graph indicating the active intents, and may create a status line for each of active intent. The status line may be generated based on the user state information, crossed with the information about the intent. For example, for a meeting intent, when the user is in the meeting location but the meeting has not started yet according to the meeting's start time, the status producer 24 may generate a status of “In meeting location, waiting for the meeting to start.” In another example, for a meeting intent, when the user is driving and it is detected that the user is on the way for the meeting location but the distance in estimated time of arrival (ETA) will make the user late for the meeting, the status producer 24 may generate a status of “On the way to <meeting location>, will be there <x>minutes late.”

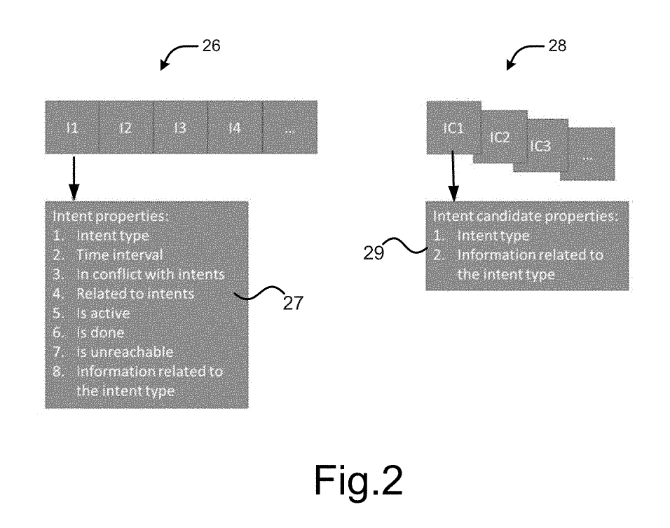

As discussed previously, the intent manager 18 may output a result (e.g., the status of each intent with regard to a current user state received by the state manager 16) as a SINC session object, which is shown and described with regard to FIG. 2. The SINC session object may be provided to a UI engine 30 (also referred to as an “interface engine 30”) to be displayed in a UI. In addition or alternatively, the SINC session object may be further used in the system, such by providing the SINC session object to other applications 65 and/or other components 60. For example, the SINC session object may be passed to another application 65 to generate and display a summary of an upcoming event, or for submission to a social media platform. In another example, the SINC session object may be passed to another component 60 to for output to a peripheral device, such as a smartwatch, Bluetooth headphones, etc.

In embodiments, the interface engine 30 may generate instances of a graphical user interface (“GUI”). The GUI may comprise an intents list and a timeline. The intents list may include graphical intent objects, where each intent object may correspond to a user intent indicated by the SINC session object. To generate the timeline, the interface engine 30 may determine various semantic time anchors based on the various states indicated by the SINC session object. Each semantic time anchor may correspond to a state indicated by the SINC session object, and may correspond to a graphical control element to which one or more intent objects may be attached. In this way, the user of the computer device 300 may drag an intent object from the intents list and drop them on a semantic time anchor in the timeline. By doing so, the user may be able to associate specific tasks/intents with specific semantic entities in their timeline. The semantic entities may be either time related (e.g., in the morning, etc.) or state related (e.g., at a specific location, in a meeting, when meeting someone, in the car, when free/available, etc.). Upon selection of an intent object from the intents list, the interface engine 30 may generate a new instance of the GUI that indicates related and/or relevant semantic time anchors in the timeline. Each time the user selects an intent object (e.g., by performing a tap and hold gesture on a touch screen), new, different, or rearranged semantic time anchors may be displayed in the GUI. In this way, the GUI may emphasize the possible places in which a particular intent/task can be added to the timeline. In addition, since the semantic anchor points are based on the various user states, the semantic time anchors are personalized to the user's timeline according to a current user state. By visualizing the different semantic entities in this manner and because the semantic anchoring only requires a drag and drop gesture, the time and effort in arranging and organizing tasks/intents may be significantly reduced. 1341 The interface engine 30 may also generate notifications or reminders when an intent object is placed in a timeline. The notifications may be used to indicate a user intent associated with a current state of the computer device 300. In embodiments, the notifications may list intents properties 27 (see e.g., FIG. 2) and/or graphical control elements, which may be used to control execution of one or more applications or components of the computer device 300. The notifications may be implemented as another instance of the timeline, a pop-up GUI (e.g., a pop-up window, etc.), a local or remote push notification, an audio output, a haptic feedback output, and/or implemented as some other a platform specific notification.

FIG. 2 illustrates an example of a list of intents 26 and a list of candidate intents 28, in accordance with various example embodiments. In embodiments, the list of intents 26 and the list of intent candidates 28 may belong to a SINC session object. The list of intents 26 may be the intents that were able to be anchored to a particular time by that the intent manager 18. In embodiments the list of intents 26 may be sorted according to each intent's time interval. Each intent in the list of intents 26 may comprise one or more of the following intents properties 27: a time interval, which may be the time span in which the intent will be active. According to this property the intents in the list 26 are sorted; an intent type, for example, meeting intent, call intent, task intent, travel intent, event intent, etc.; “in conflict with intents,” which may indicate identifiers (IDs) of other intents in the list 26 that are in time and/or location conflict with the intent; “related to intents,” which may indicate the IDs of other intents in the list 26 that the intent depends on, for example, a call intent that will be executed on the next travel is dependent on the next travel intent; “is active,” which may indicate whether the intent is active in the current user state as determined by the active intents marker 22; “is done,” which may indicate whether the intent is completed according to the current user state as determined by the intent manager 18; and “information related to the intent type,” which may indicate all other enriching information that is related to the intent and is constructed according to the intent type, for example, indicating a number the user should call when fulfilling a call intent, or indicating a means of transport the user will use when fulfilling a travel intent.

The unsorted list of intent candidates 28 may include all the intents that the intent manager 18 could not anchor into the sorted intents list 26. Therefore, the intent candidates 28 are not enriched with the data regarding the time interval since the intent manager 18 may have been unable to determine when the intent candidates 28 will be fulfilled. Whenever the state manager 16 recalculates the SINC session object, the intent candidates 28 may be considered again as candidates to be anchored to the sorted list of intents 26.

FIG. 3 illustrates the components of a computer device 300, in accordance with various example embodiments. In embodiments, computer device 300 may comprise communications circuitry 305, power management circuitry (PMC) 210, processor circuitry 315, memory 320 (also referred to as “computer-readable media 320” or “CRM 320”), network interface circuitry (NIC) 330, input/output (I/O) interface 330, display module 340, sensor hub 350, and one or more sensors 355 (also referred to as “sensor(s) 355”) coupled with each other by bus 335 at least as shown by FIG. 2.

CRM 320 may be a hardware device configured to store an OS 60 and program code for one or more software components, such as sensor data 270 and/or one or more other application(s) 65. CRM 320 may be a computer readable storage medium that may generally include a volatile memory (e.g., random access memory (RAM), synchronous dynamic RAM (SDRAM) devices, double-data rate synchronous dynamic RAM (DDR SDRAM) device, flash memory, and the like), non-volatile memory (e.g., read only memory (ROM), solid state storage (SSS), non-volatile RAM (NVRAIVI), and the like), and/or other like storage media capable of storing and recording data. Instructions, program code and/or software components may be loaded into CRM 320 by one or more network elements via network 110 and communications circuitry 305 using over-the-air (OTA) interfaces or via NIC 330 using wired communications interfaces (e.g., from application server 120, a remote provisioning service, etc.). In some embodiments, software components may be loaded into CRM 320 during manufacture of the computer device 300. In some embodiments, the program code and/or software components may be loaded from a separate computer readable storage medium into memory 320 using a drive mechanism (not shown), such as a memory card, memory stick, removable flash drive, sim card, a secure digital (SD) card, and/or other like computer readable storage medium (not shown).

During operation, memory 320 may include state provider 12, state manager 16, intent provider 14, intent manager 30, interface engine 30, operating system (OS) 60, and other application(s) 65. OS 60 may manage computer hardware and software resources and provide common services for computer programs. OS 60 may include one or more drivers or application APIs that provide an interface to hardware devices thereby enabling OS 60 and the aforementioned modules to access hardware functions without needing to know the details of the hardware itself. The state provider(s) 12 and the intent provider(s) 14 may use the drivers and/or APIs to obtain data/information from other components/sensors of the computer device 300 to determine the states and intents. The OS 60 may be a general purpose operating system or an operating system specifically written for and tailored to the computer device 300. The state provider 12, state manager 16, intent provider 14, intent manager 30, and interface engine 30 may be a collection of software modules, logic, and/or program code that enables the computer device 300 to operate according to the various example embodiments discussed herein. Other application(s) 65 may be a collection of software modules, logic, and/or program code that enables the computer device 300 to perform various other functions of the computer device 300 (e.g., social networking, email, games, word processing, and the like). In some embodiments, each of the other application(s) 65 may include APIs and/or middleware that allow the state provider 12 and the intent provider 14 to access associated data/information to determine the states and intents.

Processor circuitry 315 may be configured to carry out instructions of a computer program by performing the basic arithmetical, logical, and input/output operations of the system. The processor circuitry 315 may include one or more processors (e.g., a single-core processor, a dual-core processor, a triple-core processor, a quad-core processor, etc.), one or more microcontrollers, one or more DSPs, FPGAs (hardware accelerators), one or more graphics processing units (GPUs), etc. The processor circuitry 315 may perform the logical operations, arithmetic operations, data processing operations, and a variety of other functions for the computer device 300. To do so, the processor circuitry 315 may execute program code, logic, software modules, firmware, middleware, microcode, hardware description languages, and/or any other like set of instructions stored in the memory 320. The program code may be provided to processor circuitry 315 by memory 320 via bus 335, communications circuitry 305, NIC 330, or separate drive mechanism. On execution of the program code by the processor circuitry 315, the processor circuitry 315 may cause computer device 300 to perform the various operations and functions delineated by the program code, such as the various example embodiments discussed herein. In embodiments where processor circuitry 315 include (FPGA based) hardware accelerators as well as processor cores, the hardware accelerators (e.g., the FPGA cells) may be pre-configured (e.g., with appropriate bit streams) with the logic to perform some of the functions of state provider 12, state manager 16, intent provider 14, intent manager 18, interface engine 30, OS 60 and/or other applications 65 (in lieu of employment of programming instructions to be executed by the processor core(s)).

Sensor(s) 355 may be any device or devices that are capable of converting a mechanical motion, sound, light or any other like input into an electrical signal. For example, the sensor(s) 355 may be one or more microelectromechanical systems (MEMS) with piezoelectric, piezoresistive and/or capacitive components. In some embodiments, the sensors may include, but are not limited to, one or more audio input devices (e.g., speech/audio sensors 255), gyroscopes, accelerometers, gravimeters, compass/magnetometers, altimeters, barometers, proximity sensors (e.g., infrared radiation detector and the like), ambient light sensors, depth sensors, thermal sensors, ultrasonic transceivers, biometric sensors (e.g., bio-sensors 256), and/or positioning circuitry. The positioning circuitry may also be part of, or interact with, the communications circuitry 305 to communicate with components of a positioning network, such a Global Navigation Satellite System (GNSS) or a Global Positioning System (GPS).

Sensor hub 350 may act as a coprocessor for processor circuitry 315 by processing data obtained from the sensor(s) 355. The sensor hub 350 may include one or more processors (e.g., a single-core processor, a dual-core processor, a triple-core processor, a quad-core processor, etc.), one or more microcontrollers, one or more DSPs, FPGAs, and/or other like devices. Sensor hub 350 may be configured to integrate data obtained from each of the sensor(s) 355 by performing arithmetical, logical, and input/output operations. In embodiments, the sensor hub 350 may capable of timestamping obtained sensor data, provide sensor data to the processor circuitry 315 in response to a query for such data, buffering sensor data, continuously streaming sensor data to the processor circuitry 315 including independent streams for each sensor 355, reporting sensor data based upon predefined thresholds or conditions/triggers, and/or other like data processing functions. In embodiments, the processor circuitry 315 may include feature-matching capabilities that allows the processor circuitry 315 to recognize patterns of incoming sensor data from the sensor hub 350, and control the storage of sensor data in memory 320.

PMC 310 may be integrated circuit (e.g., a power management integrated circuit (PMIC)) or a system block in a system on chip (SoC) used for managing power requirements of the computer device 300. The power management functions may include power conversion (e.g., alternating current (AC) to direct current (DC), DC to DC, etc.), battery charging, voltage scaling, and the like. PMC 310 may also communicate battery information to the processor circuitry 315 when queried. The battery information may indicate whether the computer device 300 is connected to a power source, whether the connected power sources is wired or wireless, whether the connected power sources is an alternating current charger or a USB charger, a current voltage of the battery, a remaining battery capacity as an integer percentage of total capacity (with or without a fractional part), a battery capacity in microampere-hours, an average battery current in microamperes, an instantaneous battery current in microamperes, a remaining energy in nanowatt-hours, whether the battery is overheated, cold, dead, or has an unspecified failure, and the like. PMC 310 may be communicatively coupled with a battery or other power source of the computer device 300 (e.g., nickel-cadmium (NiCd) cells, nickel-zinc (NiZn) cells, nickel metal hydride (NiMH) cells, and lithium-ion (Li-ion) cells, a supercapacitor device, an

NIC 330 may be a computer hardware component that connects computer device 300 to a computer network via a wired connection. To this end, NIC 330 may include one or more ports and one or more dedicated processors and/or FPGAs to communicate using one or more wired network communications protocol, such as Ethernet, token ring, Fiber Distributed Data Interface (FDDI), Point-to-Point Protocol (PPP), and/or other like network communications protocols). The NIC 330 may also include one or more virtual network interfaces configured to operate with the one or more applications of the computer device 300.

I/O interface 330 may be a computer hardware component that provides communication between the computer device 300 and one or more other devices. The I/O interface 330 may include one or more user interfaces designed to enable user interaction with the computer device 300 and/or peripheral component interfaces designed to provide interaction between the computer device 300 and one or more peripheral components. User interfaces may include, but keypad are not limited to a physical keyboard or, a touchpad, a speaker, a microphone, etc. Peripheral component interfaces may include, but are not limited to, a non-volatile memory port, an audio jack, a power supply interface, a serial communications protocol (e.g., Universal Serial Bus (USB), FireWire, Serial Digital Interface (SDI), and/or other like serial communications protocols), a parallel communications protocol (e.g., IEEE 1284, Computer Automated Measurement And Control (CAMAC), and/or other like parallel communications protocols), etc.

Bus 335 may include one or more buses (and/or bridges) configured to enable the communication and data transfer between the various described/illustrated elements. Bus 335 may comprise a high-speed serial bus, parallel bus, internal universal serial bus (USB), Front-Side-Bus (FSB), a PCI bus, a PCI-Express (PCI-e) bus, a Small Computer System Interface (SCSI) bus, an SCSI parallel interface (SPI) bus, an Inter-Integrated Circuit (I2C) bus, a universal asynchronous receiver/transmitter (UART) bus, and/or any other suitable communication technology for transferring data between components within computer device 300.

Communications circuitry 305 may include circuitry for communicating with a wireless network and/or cellular network. Communications circuitry 305 may be used to establish a networking layer tunnel through which the computer device 300 may communicate with other computer devices. Communications circuitry 305 may include one or more processors (e.g., baseband processors, etc.) that are dedicated to a particular wireless communication protocol (e.g., Wi-Fi and/or IEEE 802.11 protocols), a cellular communication protocol (e.g., Long Term Evolution (LTE) and the like), and/or a wireless personal area network (WPAN) protocol (e.g., IEEE 802.15.4-802.15.5 protocols including ZigBee, WirelessHART, 6LoWPAN, etc.; or Bluetooth or Bluetooth low energy (BLE) and the like). The communications circuitry 305 may also include hardware devices that enable communication with wireless networks and/or other computer devices using modulated electromagnetic radiation through a non-solid medium. Such hardware devices may include switches, filters, amplifiers, antenna elements, and the like to facilitate the communication over-the-air (OTA) by generating or otherwise producing radio waves to transmit data to one or more other devices via the one or more antenna elements, and converting received signals from a modulated radio wave into usable information, such as digital data, which may be provided to one or more other components of computer device 300 via bus 335.

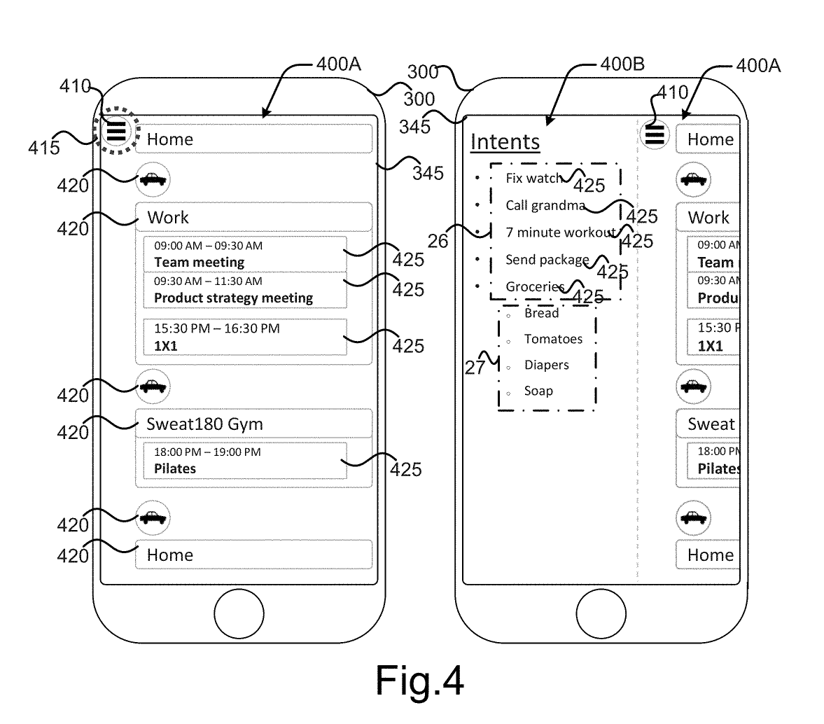

Display module 340 may be configured to provide generated content (e.g., various instances of the GUIs 400A-B, 800, and 1000A-B discussed with regard to FIGS. 4-10) to a display device for display/rendering (see e.g., displays 345, 845, and 1045 shown and described with regard to FIGS. 4-10). The display module 340 may be one or more software modules/logic that operate in conjunction with one or more hardware devices to provide data to a display device via the I/O interface 330. Depending on the type of display device used, the display module 340 may operate in accordance with one or more known display protocols, such as video graphics array (VGA) protocol, the digital visual interface (DVI) protocol, the high-definition multimedia interface (HDMI) specifications, the display pixel interface (DPI) protocol, and/or any other like standard that may define the criteria for transferring audio and/or video data to a display device. Furthermore, the display module 340 may operate in accordance with one or more remote display protocols, such as the wireless gigabit alliance (WiGiG) protocol, the remote desktop protocol (RDP), PC-over-IP (PCoIP) protocol, the high-definition experience (HDX) protocol, and/or other like remote display protocols. In such embodiments, the display module 340 may provide content to the display device via the NIC 330 or communications circuitry 305 rather than the I/O interface 330.

In some embodiments the components of computer device 300 may be packaged together to form a single package or SoC. For example, in some embodiments the PMC 310, processor circuitry 315, memory 320, and sensor hub 350 may be included in an SoC that is communicatively coupled with the other components of the computer device 300. Additionally, although FIG. 3 illustrates various components of the computer device 300, in some embodiments, computer device 300 may include many more (or less) components than those shown in FIG. 3.

FIG. 4 illustrates example GUIs 400A-B rendered in touchscreen display 345 of the computer device 300, in accordance with various embodiments. Where touchscreen display 345 (also referred to as “display 345” or “touchscreen 345”) is used, the computer device 300 may be implemented in a smartphone, tablet computer, or a laptop that includes a touchscreen. Touchscreen 345 may include any device that provides a screen on which a visual display is rendered that may be controlled by contact with a user's finger or other contact instrument (e.g., a stylus). For ease of discussion, the primary contact instrument discussed herein may be a user's finger, but any suitable contact instrument may be used in place of a finger. Non-limiting examples of touchscreen technologies that may be used to implement the touchscreen 345 may include resistive touchscreens, surface acoustic wave touchscreens, capacitive touchscreens, infrared-based touchscreens, and any other suitable touchscreen technology. The touchscreen 345 may include suitable sensor hardware and logic to generate a touch signal. A touch signal may include information regarding a location of the touch (e.g., one or more sets of (x,y) coordinates describing an area, shape or skeleton of the touch), a pressure of the touch (e.g., as measured by area of contact between a user's finger or a deformable stylus and the touchscreen 345, or by a pressure sensor), a duration of contact, any other suitable information, or any combination of such information. In some embodiments, the touchscreen 345 may stream the touch signal to other components of the computer device 300 via a communication pathway (e.g., bus 335 discussed previously).

The GUI 400A shows a timeline that presents a user's intent objects 425 as they pertain to various states 420, such as various locations, travels, meetings, calls, tasks, and/or modes of operation for a specific day. The GUI 400A may be referred to as a “timeline 400A,” “timeline screen 400A,” and the like. As an example, FIG. 4 shows the timeline 400A including work state 420, exercise state 420 (e.g., “Sweat 180 Gym” in FIG. 4), home state 420, and travel states 420 (represented by the automobile picture in FIG. 4). The work, exercise (e.g., “Sweat 180 Gym” in FIG. 4), and home states 420 may be representative of the computer device 300 being located at a particular location, and the travel states 420 may be representative of the computer device 300 traveling between locations. In embodiments, the states 420 may have been automatically populated into the timeline based on data that was mined, extracted, or obtained from the various sources discussed previously with regards to FIG. 1.

The timeline 400A may also show intent objects 425 related to the various states 420. Each of the intent objects 425 may be graphical objects, such as an icon, button, etc., that represents a corresponding intent indicated by the SINC session object discussed previously. As an example, timeline 400A shows the work state 420 may be associated with a “team meeting” intent object 425, a “product strategy meeting” intent object 425, and an “1X1” intent object 425. In addition, the exercise state 420 may be associated with the “Pilates” intent object 425. In some embodiments, at least some of the intent objects 425 may have been automatically populated into the timeline 400A based on data that was mined, extracted, or obtained from the various sources discussed previously with regards to FIG. 1. In various embodiments, the intent objects 425 may have been associated with the states 420 in a manner discussed infra.

The GUI 400A may also include a menu icon 410. The menu icon 410 may be a graphical control element that, when selected, displays a list of intents 26 as shown by GUI 400B. For example, as shown by FIG. 4, the menu icon 410 may be selected by placing a finger or stylus over the menu icon 410 and performing a tap gesture, a tap-and-hold gesture, and/or the like or near the menu icon 410. In FIG. 4, the selection using a finger or stylus is represented by the dashed circle 415, which may be referred to as “finger 415,” “selection 415,” and the like. In addition, performing the same or similar gesture on the menu icon 410 may close the intents menu. The computer device 300 may also animate a transition between the GUI 400A and the GUI 400B, and vice versa, upon receiving an input including the selection of the menu icon 410. As shown, the GUI 400B may be displayed with a minimized or partial version of the GUI 400A, although in other embodiments, the GUI 400B may be displayed on top of or over the GUI 400A (not shown).

The GUI 400B shows a list of intents 26, which may be pending user intents gathered from various sources (e.g., the various sources discussed previously with regard to FIG. 1). The GUI 400B may be referred to as an “intents menu 400B,” “intents screen 400A,” and the like. The list of intents 26 may include a plurality of intent objects 425, each of which being associated with a user intent. As an example, FIG. 4 shows the intents list 26 including a “fix watch” intent object 425, a “call grandma” intent object 425, a “7 minute workout” intent object 425, a “send package” intent object 425, and a “groceries” intent object 425. The GUI 400B may also show intents properties 27 associated with one or more of the listed intents 26. For example, as shown by FIG. 4, the intents properties 27 may be associated with the “groceries” intent, and may include “bread,” “tomatoes,” “diapers,” and “soap.” In embodiments, the user of computer device 300 may manipulate the graphical objects associated with the intent objects 425 in order to associate or link individual intent objects 425 with semantic time anchors in a manner discussed infra.

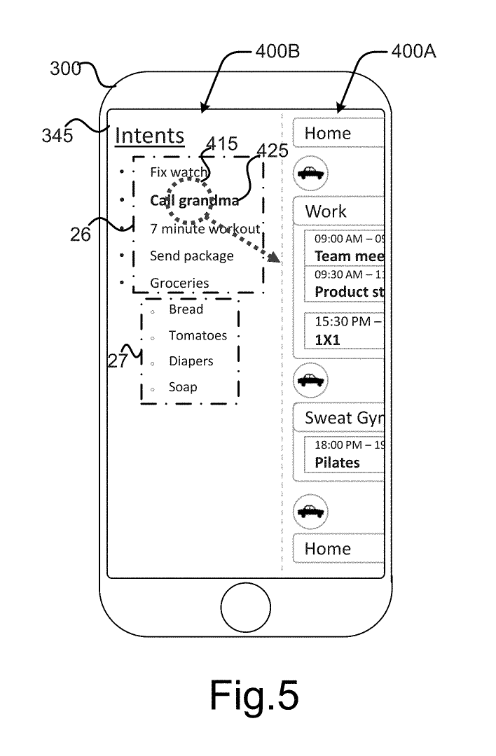

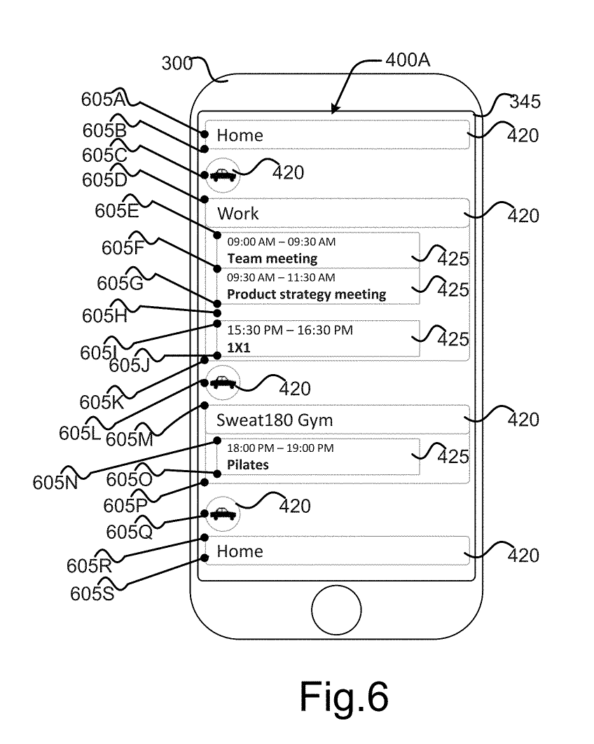

FIG. 5 illustrates a user selection of an intent object 425 from the intents list 26 of GUI 400B to the timeline of GUI 400A, in accordance with various embodiments. In embodiments, the user of the computer device 300 may select an individual intent object 425 from the intents list 26 by performing a tap or tap-and-hold gesture on the intent object 425. Upon selection 415, the selected intent object 425 may be highlighted or visually distinguished from the other listed intent objects 425. For example, as shown by FIG. 4, the “call grandma” intent object 425 has been selected by the user performing a tap-and-hold gesture on the “call grandma” intent object 425, causing the “call grandma” intent object 425 to be highlighted in bold text. In other embodiments, the selected intent object 425 may be highlighted using any method, such as changing a text color, font style, rendering an animation, etc. Upon performing a drag gesture towards the timeline (indicated by the dashed arrow in FIG. 4), the intents menu 400B may be minimized and the timeline screen 400A may be reopened as shown by FIG. 6.

FIG. 6 illustrates another instance of GUI 400A with a plurality of semantic time anchors 605A-S (collectively referred to as “semantic time anchors 605,” “anchors 605,” and the like) to which a selected intent object 425 can be attached, in accordance with various embodiments.

In embodiments, each of the anchors 605 may be a graphical control element that represent a particular semantic time. A semantic time may be a time represented by a state of the computer device 300 and various other contextual factors, such as an amount of time that the computer device 300 is at a particular location, an arrival time of the computer device 300 at a particular location, a departure time of the computer device 300 from a particular location, a distance traveled between two or more locations by the computer device 300, a travel velocity of the computer device 300, position and orientation changes of the computer device 300, media settings of the computer device 300, information contained in one or more messages sent by the computer device 300, information contained in one or more messages received by the computer device 300, an environment in which the computer device 300 is located, and/or other like contextual factors.

In the example shown by FIG. 6, anchor 605A may represent a “morning” semantic time; 605B may represent a “before leaving work” semantic time; 605C may represent a “on my way to work” semantic time; 605D may represent an “arrive at work” semantic time; 605E may represent a “before first meeting” semantic time; 605F may represent an “after first meeting” and/or “before second meeting” semantic time; 605G may represent an “after second meeting” semantic time; 605H may represent a “free time at work” semantic time; 605I may represent a “before 1X1” semantic time; 605J may represent an “after 1X1” semantic time; 605K may represent a “before leaving work” semantic time; 605L may represent a “leaving work” and/or “on my way to the gym” semantic time; 605M may represent a “arrive at gym” semantic time; 605N may represent a “when class starts” semantic time; 605O may represent a “when class ends” semantic time; 605P may represent a “before leaving gym” semantic time; 605Q may represent a “leaving gym” and/or “on my way home” semantic time; 605R may represent a “arrive at home” semantic time; and 605S may represent a “while at home” semantic time.

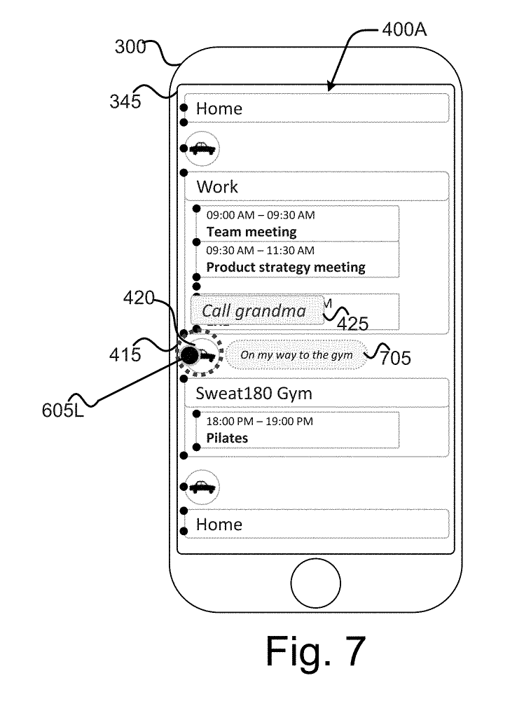

Upon selection of an intent object 425 by the user, another instance of the GUI 400A may be displayed showing a plurality of semantic time anchors 605, which are shown by FIG. 6 as circles dispersed throughout various states 420 and intent objects 425 in the timeline 400A. In this way, the user can see a current association between individual intent objects 425 and individual semantic times before selecting an anchor 605 to be associated with the selected intent object 425. In some embodiments, since certain intent objects 425 may be fulfilled at particular states 420, the timeline 400A may only display anchors 605 that are relevant or related to the selected intent object 425. In embodiments, the user may select an anchor 605 by performing a release or drop gesture over the desired anchor 605 as shown by FIG. 7.

FIG. 7 illustrates another instance of GUI 400A showing a selection of an anchor 605 to be associated with a selected intent object 425, in accordance with various embodiments. In embodiments, the user may make a selection 415 of an anchor 605 by dragging a selected intent towards an anchor 605 or by holding the selected intent object 425 at or near the anchor 605 (also referred to as a “hovering operation” or “hovering”). As a selected intent object 425 approaches an anchor 605 and/or when the selected intent object 425 is hovered over the an anchor 605, the closest anchor 605 to the selected intent object 425 may be highlighted, for example, by enlarging the size of the anchor 605 relative to the size of the other anchors 605 as shown by FIG. 7. In addition, a visual representation of an associated semantic time 705 may be displayed when the selected intent object 425 approaches or is hovered over an anchor 605. Furthermore, a visual representation of the selected intent object 425 may be visually inserted into the timeline 400A to show where the selected intent object 425 will be placed upon selection of the anchor 605.

For example, as shown by FIG. 7, the user may drag an object representing the selected intent object 425 “call grandma” to the anchor 605L. When the user hovers the “call grandma” intent object 425 over the anchor 605L, the anchor 605L may be enlarged, and a semantic time 705 “on my way to the gym” associated with the anchor 605L may be visually inserted into the timeline 400A. In this way, the user may see that, upon selection of the anchor 605L, the “call grandma” intent object 425 will be placed in the “on my way to the gym” portion of the timeline 400A. In some embodiments, the visual insertion of the associated semantic time may include displaying the semantic time as a transparent object, highlighting the semantic time using different text color or font styles, and/or the like.

In embodiments, the user may hover the selected intent object 425 over different anchors 605 until release. Additionally, the user may cancel the action and return to the original state of the timeline 400A. In various embodiments, upon releasing the selected intent object 425 at or near an anchor 605, another instant of the timeline 400A may be generated with the selected intent object 425 placed at the selected anchor 605, and with new anchors 605 and/or listed intents 26 that may be calculated in the same or similar manner as discussed previously with regard to FIG. 1.

For example, when the user drops a location based intent object 425 into the timeline 400A, the computer device 300 may recalculate one or more additional or alternative anchors 605 for future intent objects 425. In another example, when the user drops a phone call or contact based intent object 425 (e.g., “call grandma” as shown by FIG. 7) into the timeline 400A, a notification (or reminder) for that intent object 425 may be generated. In embodiments, the notification may include intents properties 27 and/or one or more graphical control elements that, when selected, activate one or more other applications/components of the computer device 300. For example, when the “call grandma” intent object 425 is dropped into the timeline 400A, a notification may be generated that includes contact information (e.g., a phone number, email address, mailing address, etc.) and a graphical control element to contact the subject of the intent (e.g., a contact listed as “grandma”) using one or more permitted/available communications methods (e.g., making a cellular phone call, sending an email or text message, and the like). The notification may be implemented as another instance of the timeline 400A, a pop-up GUI (e.g., a pop-up window, etc.), a local or remote push notification, an audio output, a haptic feedback output, and/or implemented as some other a platform specific notification.

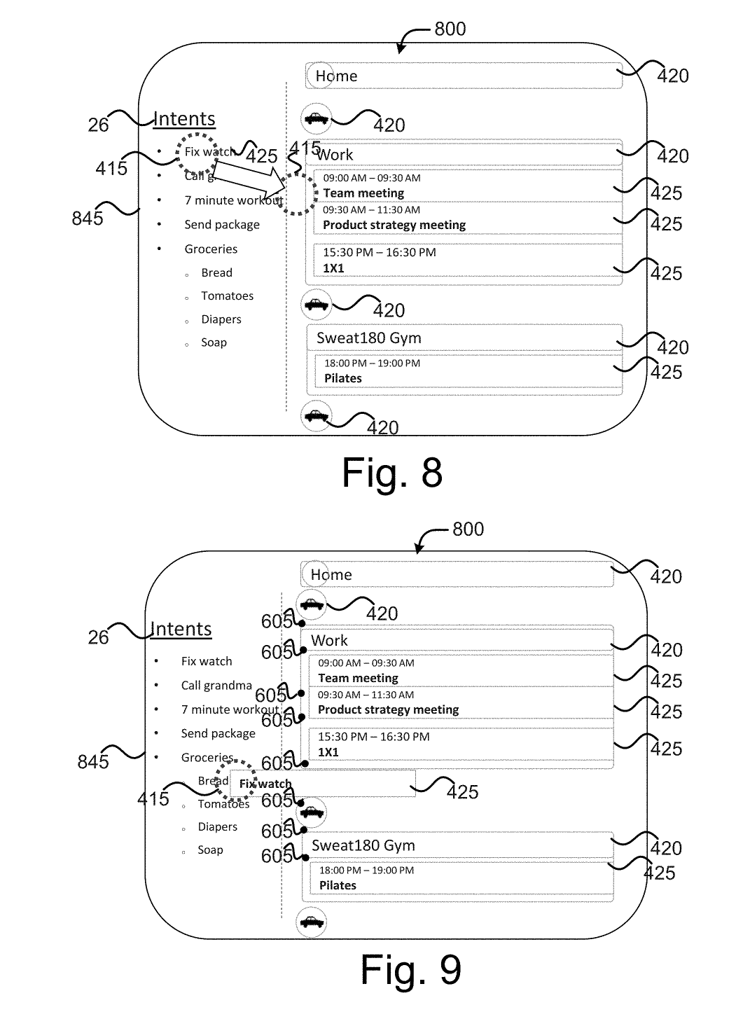

FIGS. 8-9 illustrate an example GUI 800 rendered in computer display 845 associated with the computer device 300, in accordance with various embodiments. Where computer display 845 (also referred to as “display 845”) is used, the computer device 300 may be implemented in a desktop personal computer, a laptop, smart television (TV), a video game console, a head-mounted display device, a head-up display device, and/or the like. In some embodiments, the computer device 300 may be implemented in a smartphone or tablet that is capable of providing content to display 845 via a wired or wireless connection using one or more remote display protocols. Display 845 may be any type of output device that is capable of presenting information in a visual form based on received electrical signals. Display 845 may be a light-emitting diode (LED) display device, an organic LED (OLED) display device, a liquid crystal display (LCD) device, a quantum dot display device, a projector device, and/or any other like display device. Furthermore, the aforementioned display device technologies are generally well known, and a description of the functionality of the display 845 is omitted for brevity.

The GUI 800 may be substantially similar as GUIs 400A-B discussed previously with regard to FIGS. 4-7. However, since display 845 may be larger and include more display space than the touchscreen 345, the GUI 800 may show both a timeline portion and a list of intents 26 together. The user of the computer device 300 may use a cursor of a pointer device (e.g., a computer mouse, a trackball, a touchpad, pointing stick, remote control, joystick, a hand or arm using a video and/or motion sensing input device, or any other user input device) to make a selection 415 of an intent object 425 from the list of intents 26 and place the selected intent object 425 into the timeline.

Referring to FIG. 8, the user may select an intent object 425 by placing the cursor 415 over an intent object 425 and performing a click-and-hold operation on the intent object 425. The user may then drag the selected intent object 425 towards the timeline portion of the GUI 800 in a similar manner as discussed previously with regard to FIGS. 3-7. As the user drags the selected intent object 425 towards the timeline portion of GUI 800, another instance of the GUI 800 may be generated with includes the anchors 605, which is shown by FIG. 9. The user may then drop the selected intent object 425 at or near an anchor 605 to associate the selected intent object 425 with that anchor 605. In other embodiments, the user may select an intent object 425 by performing a double-click on the intent object 425, and may then double click an anchor 605 to associate the selected intent object 425 with the selected anchor 605.

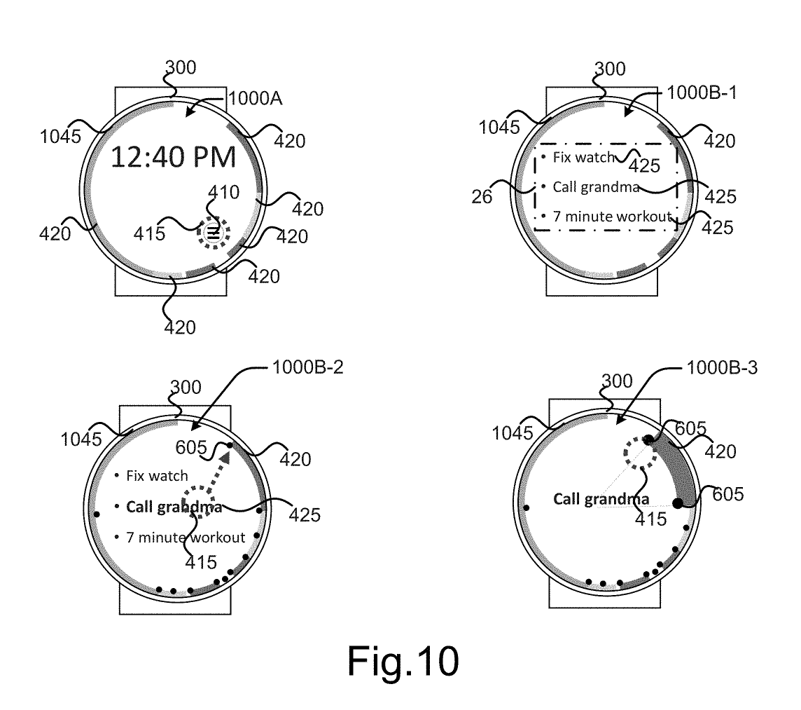

FIG. 10 illustrates example GUIs 1000A and 1000B-1 to 1000B-3 (collectively referred to as “GUI 1000B” or “GUIs 1000B”) rendered in touchscreen display 1045 of the computer device 300, in accordance with various embodiments. Where touchscreen 1045 is used, the computer device 300 may be implemented in a smartwatch or other like wearable computer device.

GUI 1000A shows a home screen that presents a user's intent objects 425 as they pertain to various states 420. The GUI 1000A may be referred to as “home 1000A,” “home screen 1000A,” and the like. The intent objects 425 and the states 420 may be the same or similar as the intent objects 425 and states 420 discussed previously. The GUI 1000A may include a timeline that surrounds or encompasses the home screen portion of the GUI 1000A, which is represented by the various states 420 in FIG. 10. In embodiments, the states 420 may have been automatically populated into the timeline based on data that was mined, extracted, or obtained from the various sources discussed previously with regards to FIG. 1. GUI 1000A also includes the menu icon 410, which may be a graphical control element that is the same or similar to menu icon 410 discussed previously. The menu icon 410 may be selected by placing a finger over the menu icon 410 (represented by the dashed circle 415 in FIG. 10) and performing a tap gesture, a tap-and-hold gesture, and/or the like at or near the menu icon 410. When the menu icon 410 is selected, the computer device 300 may display a list of intents 26 as shown by GUI 1000B. The computer device 300 may animate a transition between the GUI 1000A and GUI 1000B upon receiving an input including the selection of the menu icon 410.

The GUIs 1000B shows a list of intents 26 that includes intent objects 425. As shown, the timeline portion of GUIs 1000B may surround or enclose the intents list 26. The GUIs 1000B may be referred to as an “intents menu 1000B,” “intents screen 1000B,” and the like. Each of the GUIs 1000B may represent an individual instance of the same GUI. For example, GUI 1000B-1 may represent a first instance of intents menu 1000B, which displays the intents list 26 after the menu icon 410 has been selected.

GUI 1000B-2 may represent a second instance of the intents menu 1000B, which shows a selection 415 of the “call grandma” intent 1025. Upon selection 415 of the “call grandma” intent 1025, the selected intent 1025 may be visually distinguished from the other intent objects 425, and various semantic time anchors 605 (e.g., the black circles in FIG. 10) may be generated and displayed in relation to associated states 420. The intent objects 425 may be visually distinguished in a same or similar manner as discussed previously with regard to FIGS. 4-9. For the sake of clarity, only some of the semantic time anchors 605 and intent objects 425 have been labeled in the GUIs 1000B of FIG. 10. As the selected intent object 425 is dragged towards a semantic time anchor 605 (represented by the dashed arrow in GUI 1000B-2), GUI 1000B-3 may be generated to visually distinguish the anchors 605 and state 420 closest to the drag operation from other anchors 605 and states 420.

GUI 1000B-3 may represent a third instance of the intents menu 1000B, which shows the selected “call grandma” intent 1025 being hovered over an anchor 605. As shown by FIG. 10, the user may drag an object representing the selected intent 1025 “call grandma” to the anchor 605. When the user hovers 415 the “call grandma” intent 1025 over the anchor 605, the anchor 605 may be enlarged. In addition, as shown by GUI 1000B-3, the state 420 closest to the selection 415 may also be visually distinguished from the other states 420 by enlarging or magnifying the closest state 420. Furthermore, other anchors 605 associated with the closest state 420 may be enlarged with the closest state 420 as shown by GUI 1000B-3. In this way, the user may better see where the selected intent 1025 will be placed in timeline portion of the GUI 1000B.

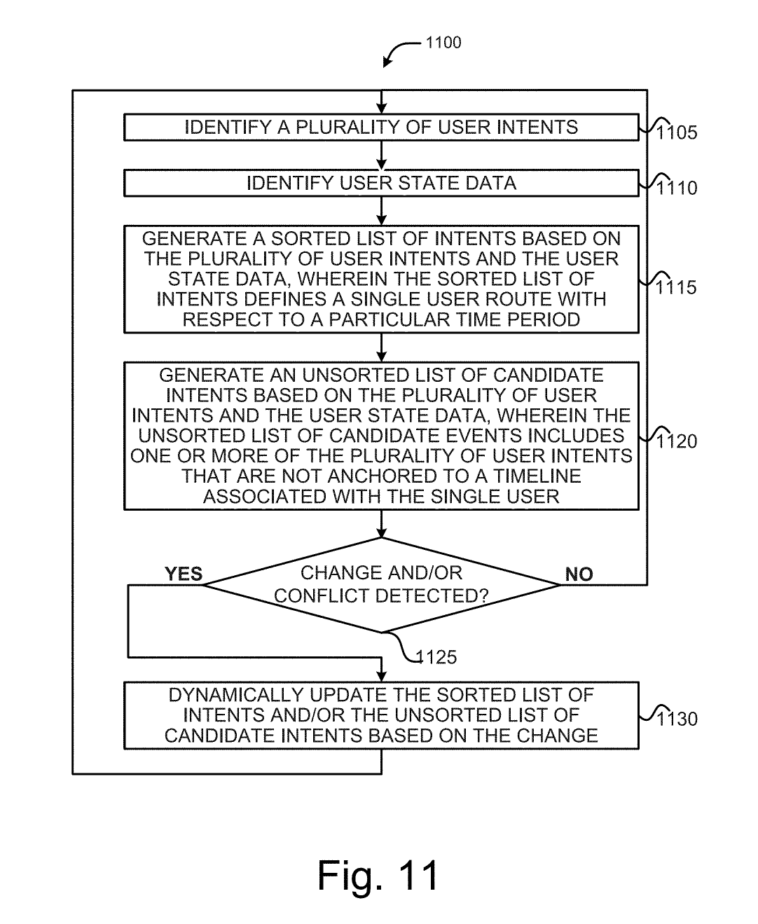

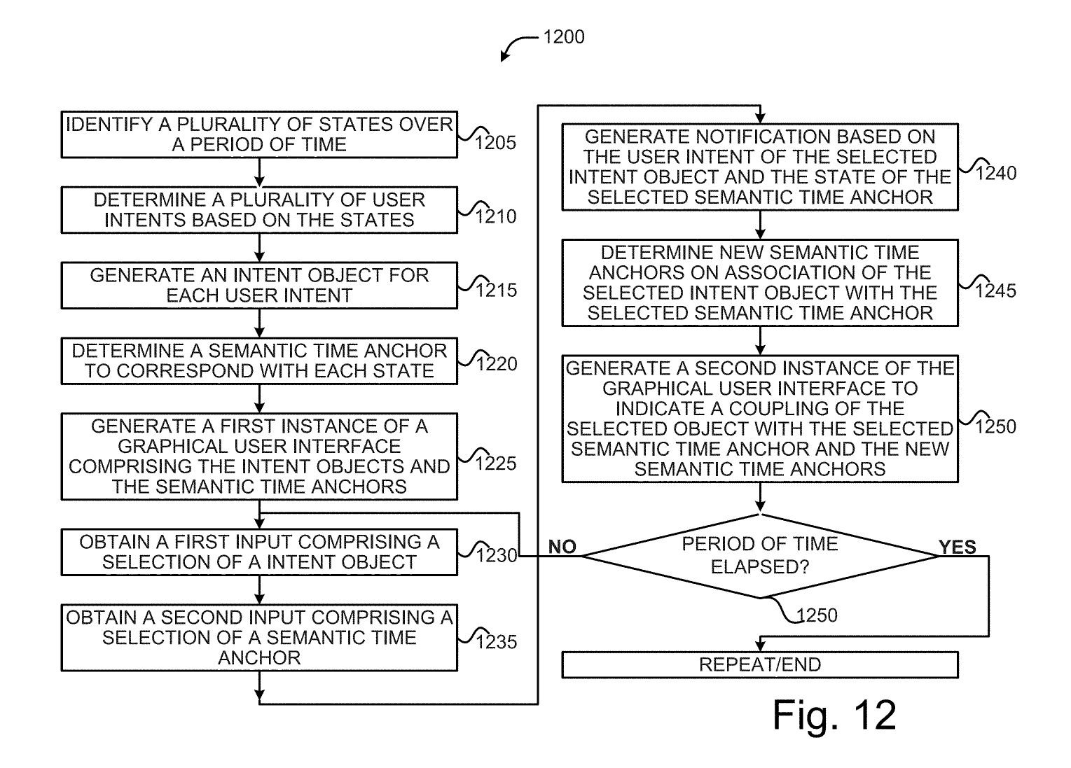

FIGS. 11-13 illustrate processes 1100-1300 for implementing the previously described embodiments. The processes 1100-1300 may be implemented as a set of instructions (and/or bit streams) stored in a machine- or computer-readable storage medium, such as CRM 320 and/or computer-readable media 1404, and performed by a client system (with processor cores and/or hardware accelerators), such as the computer device 300 discussed previously. While particular examples and orders of operations are illustrated in FIGS. 11-13, in various embodiments, these operations may be re-ordered, separated into additional operations, combined, or omitted altogether. In addition, the operations illustrated in each of FIGS. 11-13 may be combined with operations described with regard to other example embodiments and/or one or more operations described with regard to the non-limiting examples provided herein.

FIG. 11 illustrates a process 1100 of the state provider 12, state manager 14, intent provider 14, and intent manager 18 for determining user states and generating a list of intents 26, in accordance with various embodiments. At operation 1105, the computer device 300 may implement the intent manager 18 to identify a plurality of user intents based on intent data from the intent provider(s) 16. At operation 1110, the computer device 300 may implement the state manager 14 to identify a user state based on user state data from the state provider(s) 12. At operation 1115, the computer device 300 may implement the intent manager 18 to generate a time sorted list of intents 26 based on the plurality of user intents and the user state data, wherein the time sorted list of events is to define a user route with respect to a particular time period (e.g., a day, week, month, etc.). In one example, the computer device 300 implementing the intent manager 18 may document (e.g., mark) a relationship between the user state data and one or more of the plurality of user intents. At operation 1120, the computer device 300 may implement the intent manager 18 to generate an unsorted list of candidate intents 28 based on the plurality of user intents and the user state data, wherein the unsorted list of candidate intents 26 is to include one or more of the plurality of user intents that are not anchored to a timeline associated with the user route.

At operation 1125, the computer device 300 may implement the intent manager 18 to determine whether there has been a change in the user state data, a change in the plurality of user intents, a conflict between two or more of the plurality of user intents, etc. If at operation 1125 the computer device 300 implementing the intent manager 18 determines that there has been a change, the computer device 300 may proceed to operation 1130, where the computer device 300 may implement the intent manager 18 to dynamically update the sorted list of intents 26 in response to the detected change and/or conflict. After performing operation 1130, the computer device 300 may repeat the process 1100 as necessary or end/terminate. If at operation 1125 the computer device 300 implementing the intent manager 18 determines that there has been a change, the computer device 300 proceed back to operation 1105 to repeat the process 1100 as necessary, or the process 1100 may end/terminate.

FIG. 12 illustrates a process 1200 of the interface engine 30 for generating various GUI instances, in accordance with various embodiments. At operation 1205, the computer device 300 may implement the intent manager 18 and/or state manager 16 to identify a plurality of states over a period of time. In some embodiments, the computer device 300 may also implement the intent manager 18 to identify/determine one or more the contextual factors based on the various states. At operation 1210, the computer device 300 may implement the intent manager 18 to determine a plurality of user intents based on plurality of states and/or the contextual factors. At operation 1215, the computer device 300 may implement the interface engine 30 to generate an intent object 425 for each of the determined/identified user intents. At operation 1220, the computer device 300 may implement the interface engine 30 to determine one or more semantic time anchors 605 to correspond with each state of the plurality of states. At operation 1225, the computer device 300 may implement the interface engine 30 to generate a first instance of a GUI comprising the intent objects 425 and the semantic time anchors 605.

At operation 1230, the computer device 300 may implement the I/O interface 330 to obtain a first input comprising a selection 415 of an intent object. In embodiments, the selection 415 may be a tap-and-hold gesture, a point-click-hold operation, and the like. At operation 1235, the computer device 300 may implement the I/O interface 330 to obtain a second input comprising a selection of a semantic time anchor 605. In embodiments, the selection of the semantic time anchor 605 may be a drag gesture toward the semantic time anchor 605, a double-click operation, and the like. At operation 1240, the computer device 300 may implement the interface engine 30 to generate a notification or reminder based on the user intent associated with the selected intent object 425 and a state associated with the selected semantic time anchor 605. At operation 1245, the computer device 300 may implement the interface engine 30 to determine new semantic time anchors 605 based on the association of the selected intent object 425 with the selected semantic time anchor 605. In some embodiments, the computer device 300 at operation 1245 may also implement the intent manager 18 to identify new user intents based on the association of the selected intent object 425 with the selected semantic time anchor 605, and may implement the interface engine 30 to generate new intent objects 425 based on the newly identified user intents.

At operation 1250, the computer device 300 may implement the interface engine 30 to generate a second instance of the GUI to indicate a coupling of the selected intent object 425 with the selected semantic time anchor 605 and the new semantic time anchors 605 determined at operation 1245. In some embodiments, the second instance of the GUI may also include the new intent objects 425, if generated at operation 1245. At operation 1255, the computer device 300 may implement the interface engine 30 and/or the intent manager 18 to determine whether the period of time has elapsed. If at operation 1255 the computer device 300 implementing the interface engine 30 and/or the intent manager 18 determines that the period of time has not elapsed, then the computer device 300 may proceed back to operation 1230 and implement the I/O interface 330 to obtain another first input comprising a selection of an intent object 425. If at operation 1255 the computer device 300 determines that the period of time has elapsed, then the computer device 300 may proceed back to operation 1205 to repeat the process 1200 as necessary.

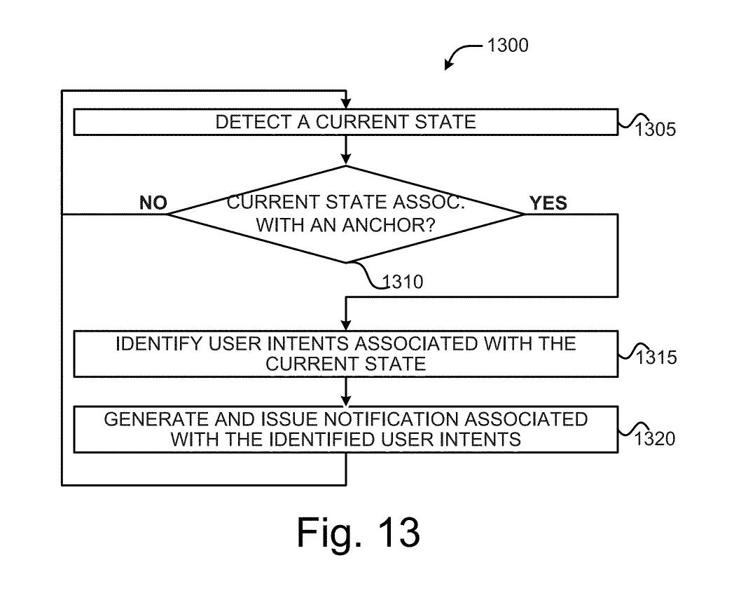

FIG. 13 illustrates a process 1300 of the interface engine 30 for generating and issuing notifications, in accordance with various embodiments. At operation 1305, the computer device 300 may implement the state manager 16 and/or the intent manager 18 to detect a current state of the computer device 300. At operation 1310, the computer device 300 may implement the intent manager 18 to determine if the current state is associated with any of the semantic time anchors 605 in a timeline. If the computer device 300 implementing the intent manager 18 determines that the current state is not associated with any semantic time anchors 605, then the computer device 300 may proceed back to operation 1305 and may implement the state manager 16 and/or the intent manager 18 to detect the current state of the computer device 300. If the computer device 300 implementing the intent manager 18 determines that the current state is associated with a semantic time anchor 605, then the computer device 300 may proceed to operation 1315 and may implement the intent manager 18 to identify one or more user intents that are associated with the current state. At operation 1320, the computer device 1320 may implement the intent manager 18 and/or the interface engine 30 to generate and issue a notification associated with the identified one or more user intents. After operation 1320, the process 1300 may end or repeat as necessary.

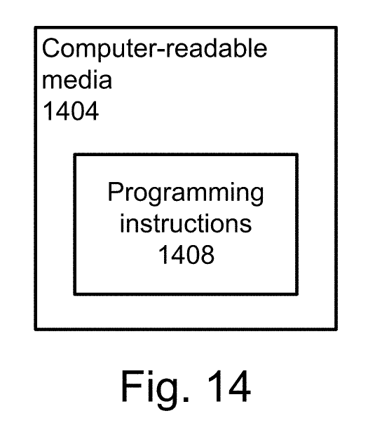

FIG. 14 illustrates an example computer-readable media 1404 that may be suitable for use to store instructions that cause an apparatus, in response to execution of the instructions by the apparatus, to practice selected aspects of the present disclosure. In some embodiments, the computer-readable media 1404 may be non-transitory. In some embodiments, computer-readable media 1404 may correspond to CRM 320 and/or any other computer-readable media discussed herein. As shown, computer-readable storage medium 1404 may include programming instructions 1408. Programming instructions 1408 may be configured to enable a device, for example, computer device 300 or some other suitable device, in response to execution of the programming instructions 1208, to implement (aspects of) any of the methods or elements described throughout this disclosure related to generating and displaying user interfaces to create and manage optimal day routes for users. In some embodiments, programming instructions 1408 may be disposed on computer-readable media 1404 that is transitory in nature, such as signals.

Any combination of one or more computer-usable or computer-readable media may be utilized. The computer-usable or computer-readable media may be, for example, but not limited to, an electronic, magnetic, optical, electromagnetic, infrared, or semiconductor system, apparatus, device, or propagation medium. More specific examples (a non-exhaustive list) of the computer-readable media would include the following: an electrical connection having one or more wires, a portable computer diskette, a hard disk, RAM, ROM, an erasable programmable read-only memory (for example, EPROM, EEPROM, or Flash memory), an optical fiber, a portable compact disc read-only memory (CD-ROM), an optical storage device, a transmission media such as those supporting the Internet or an intranet, or a magnetic storage device. Note that the computer-usable or computer-readable media could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable media may be any medium that can contain, store, communicate, propagate, or transport the program for use by or in connection with the instruction execution system, apparatus, or device. The computer-usable media may include a propagated data signal with the computer-usable program code embodied therewith, either in baseband or as part of a carrier wave. The computer-usable program code may be transmitted using any appropriate medium, including but not limited to wireless, wireline, optical fiber cable, radio frequency, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations or block diagrams of methods, apparatus (systems) and computer program products according to embodiments of the disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means that implement the function/act specified in the flowchart or block diagram block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide processes for implementing the functions/acts specified in the flowchart or block diagram block or blocks.

Some non-limiting examples are provided below.

Example 1 may include a computer device comprising: a state manager to be operated by one or more processors, the state manager to determine various states of the computer device; an intent manager to be operated by the one or more processors, the intent manager to determine various user intents associated with the various states; and an interface engine to be operated by the one or more processors, the interface engine to generate instances of a graphical user interface of the computer device, wherein to generate the instances, the interface engine is to: determine various semantic time anchors based on the various states, wherein each semantic time anchor of the various semantic time anchors corresponds to a state of the various states, and generate an instance of the graphical user interface comprising various objects and the various semantic time anchors, wherein each object of the various objects corresponds to a user intent of the various user intents.

Example 2 may include the computer device of example 1 and/or some other examples herein, wherein each state comprises one or more of a location of the computer device, a travel velocity of the computer device, and a mode of operation of the computer device.

Example 3 may include the computer device of example 1 and/or some other examples herein, wherein the interface engine is to generate another instance of the graphical user interface to indicate a new association of a selected object with a selected semantic time anchor.

Example 4 may include the computer device of example 3 and/or some other examples herein, further comprising: an input/output (I/O) device to facilitate a selection of the selected object through the graphical user interface.

Example 5 may include the computer device of example 4 and/or some other examples herein, wherein: selection of the selected object comprises a tap-and-hold gesture when the I/O device comprises a touchscreen device or a point-and-click when the I/O device comprises a pointer device, and selection of the selected semantic time anchor comprises release of the selected object at or near the selected semantic time anchor.

Example 6 may include the computer device of example 4 and/or some other examples herein, wherein the interface engine is to highlight a semantic time anchor when the selected object is dragged towards the semantic time anchor prior to the release of the selected object.

Example 7 may include the computer device of examples 3-6 and/or some other examples herein, wherein the interface engine is to: determine various new semantic time anchors based on an association of the selected object with the selected semantic time anchor; and generate another instance of the graphical user interface to indicate the selection of the selected semantic time anchor and the various new semantic time anchors.

Example 8 may include the computer device of example 6 and/or some other examples herein, wherein: the intent manager is to determine various new user intents based on the selected semantic time anchor; and the interface engine is to generate various new objects corresponding to the various new user intents, and generate another instance of the graphical user interface to indicate the various new objects and only new semantic time anchors of the various new semantic time anchors associated with the various new user intents.

Example 9 may include the computer device of examples 1-8 and/or some other examples herein, wherein: the state manager is to determine a current state of the computer device; the intent manager is to identify individual user intents associated with the current state; and the interface engine to generate a notification to indicate the individual user intents associated with the current state.

Example 10 may include the computer device of example 9 and/or some other examples herein, wherein the notification is one or more of another instance of the graphical user interface, a pop-up graphical user interface, a local push notification, a remote push notification, an audio output, or a haptic feedback output.

Example 11 may include the computer device of examples 9-10 and/or some other examples herein, wherein the notification comprises a graphical control element to, upon selection of the graphical control element, control execution of an application associated with the individual user intents.

Example 12 may include the computer device of example 1 and/or some other examples herein, wherein, to determine the various states, the state manager is to: obtain location data from positioning circuitry of the computer device or from modem circuitry of the computer device; obtain sensor data from one or more sensors of the computer device; obtain application data from one or more applications implemented by a host platform of the computer device; and determine one or more contextual factors associated with each of the various states based on one or more of the location data, the sensor data, and the application data.

Example 13 may include the computer device of example 12 and/or some other examples herein, wherein the one or more contextual factors comprise one or more of an amount of time that the computer device is at a particular location, an arrival time at a particular location, a departure time from a particular location, a distance traveled between two or more locations, a travel velocity of the computer device, position and orientation changes of the computer device, media settings of the computer device, information contained in one or more messages sent by the computer device, information contained in one or more messages received by the computer device, and an environment in which the computer device is located.

Example 14 may include the computer device of examples 1-13 and/or some other examples herein, wherein the computer device is implemented in a wearable computer device, a smartphone, a tablet, a laptop, a desktop personal computer, a head-mounted display device, a head-up display device, or a motion sensing input device.

Example 15 may include one or more computer-readable media including instructions, which when executed by a computer device, causes the computer device to: determine a plurality of states during a predefined period of time; determine a plurality of user intents; generate a first instance of a graphical user interface comprising a plurality of objects and a plurality of semantic time anchors, wherein each object of the plurality of objects corresponds to a user intent of a plurality of user intents; obtain a first input comprising a selection of an object of the plurality of objects; obtain a second input comprising a selection of a semantic time anchor of the plurality of semantic time anchors; generate a second instance of the graphical user interface to indicate a coupling of the selected object with the selected semantic time anchor; and generate a notification to indicate a user intent of the selected object upon occurrence of a state that corresponds with the selected semantic time anchor. In embodiments, the one or more computer-readable media may be non-transitory computer-readable media.

Example 16 may include the one or more computer-readable media of example 15 and/or some other examples herein, wherein the plurality of states comprise a location of the computer device, a time of day, a date, a travel velocity of the computer device, and a mode of operation of the computer device.

Example 17 may include the one or more computer-readable media of example 15 and/or some other examples herein, wherein: the first input comprises a tap-and-hold gesture when an input/output (I/O) device of the computer device comprises a touchscreen display or the first input comprises a point-and-click when the I/O device comprises a pointer device, and the second input comprises release of the selected object at or near the selected semantic time anchor.

Example 18 may include the one or more computer-readable media of example 17 and/or some other examples herein, wherein the instructions, when executed by the computer device, causes the computer device to: visually distinguish the selected semantic time anchor when the selected object is dragged at or near the selected semantic time anchor and prior to the release of the selected object.

Example 19 may include the one or more computer-readable media of examples 17-18 and/or some other examples herein, wherein the instructions, when executed by the computer device, causes the computer device to: determine a plurality of new semantic time anchors based on the selected semantic time anchor; and generate the second instance of the graphical user interface to indicate the plurality of new semantic time anchors.

Example 20 may include the one or more computer-readable media of example 19 and/or some other examples herein, wherein the instructions, when executed by the computer device, causes the computer device to: determine a plurality of new user intents based on the selected semantic time anchor; generate a plurality of new objects corresponding to the plurality of new user intents; and generate the second instance of the graphical user interface to indicate the plurality of new objects.

Example 21 may include the one or more computer-readable media of examples 15-20 and/or some other examples herein, wherein the notification comprises a graphical control element, and upon selection of the graphical control element, the instructions, when executed by the computer device, causes the computer device to: control execution of an application associated with the user intent indicated by the notification.

Example 22 may include the one or more computer-readable media of example 21 and/or some other examples herein, wherein the notification is one or more of another instance of the graphical user interface, a pop-up graphical user interface, a local push notification, a remote push notification, an audio output, or a haptic feedback output.

Example 23 may include the one or more computer-readable media of example 15 and/or some other examples herein, wherein the instructions, when executed by the computer device, causes the computer device to: obtain location data from positioning circuitry of the computer device or from modem circuitry of the computer device; obtain sensor data from one or more sensors of the computer device; obtain application data from one or more applications implemented by a host platform of the computer device; and determine one or more contextual factors based on one or more of the location data, the sensor data, and the application data; and determine the plurality of states based on the one or more contextual factors.

Example 24 may include the one or more computer-readable media of example 23 and/or some other examples herein, wherein the one or more contextual factors comprise one or more of an amount of time that the computer device is at a particular location, an arrival time at a particular location, a departure time from a particular location, a distance traveled between two or more locations, a travel velocity of the computer device, position and orientation changes of the computer device, media settings of the computer device, information contained in one or more messages sent by the computer device, information contained in one or more messages received by the computer device, and an environment in which the computer device is located.

Example 25 may include the one or more computer-readable media of examples 15-24 and/or some other examples herein, wherein the computer device is implemented in a wearable computer device, a smartphone, a tablet, a laptop, a desktop personal computer, a head-mounted display device, a head-up display device, or a motion sensing input device.

Example 26 may include a method to be performed by a computer device, the method comprising: identifying, by a computer device, a plurality of user states and a plurality of user intents; determining, by the computer device, a plurality of semantic time anchors, wherein each semantic time anchor of the plurality of semantic time anchors corresponds with a state of the plurality of states; generating, by the computer device, a plurality of intent objects, wherein each intent object corresponds with a user intent of the plurality of user intents; generating, by the computer device, a first instance of a graphical user interface comprising a timeline and an intents menu, wherein the timeline includes the plurality of semantic time anchors and the intents menu includes the plurality of plurality of intent objects; obtaining, by the computer device, a first input comprising a selection of an intent object from the intents menu; obtaining, by the computer device, a second input comprising a selection of a semantic time anchor in the timeline; generating, by the computer device, a second instance of the graphical user interface to indicate an association of the selected intent object with the selected semantic time anchor; and generating, by the computer device, a notification to indicate a user intent associated with the selected intent object upon occurrence of a state associated with the selected semantic time anchor.

Example 27 may include the method of example 26 and/or some other examples herein, wherein the plurality of user states comprise a location of the computer device, a time of day, a date, a travel velocity of the computer device, and a mode of operation of the computer device.

Example 28 may include the method of example 26 and/or some other examples herein, wherein: the first input comprises a tap-and-hold gesture when an input/output (I/O) device of the computer device comprises a touchscreen device or the first input comprises a point-and-click when the I/O device comprises a pointer device, and the second input comprises release of the selected object at or near the selected semantic time anchor.

Example 29 may include the method of example 28 and/or some other examples herein, wherein generating the second instance of the graphical user interface comprises: generating, by the computer device, the selected semantic time anchor to be visually distinguish from non-selected semantic time anchors when the selected object is dragged to the selected semantic time anchor and prior to the release of the selected object.

Example 30 may include the method of examples 28-29 and/or some other examples herein, wherein generating the second instance of the graphical user interface comprises: determining, by the computer device, a plurality of new semantic time anchors based on the selected semantic time anchor; and generating, by the computer device, the second instance of the graphical user interface to indicate the plurality of new semantic time anchors.

Example 31 may include the method of example 30 and/or some other examples herein, wherein generating the second instance of the graphical user interface comprises: determining, by the computer device, a plurality of new user intents based on the selected semantic time anchor; generating, by the computer device, a plurality of new intent objects corresponding to the plurality of new user intents; and generating, by the computer device, the second instance of the graphical user interface to indicate the plurality of new intent objects.

Example 32 may include the method of examples 26-31 and/or some other examples herein, wherein the notification comprises a graphical control element, and the method further comprises: detecting, by the computer device, a current state of the computer device; issuing, by the computer device, the notification when the current state matches the state associated with the selected semantic time anchor; and executing, by the computer device, an application associated with the user intent indicated by the notification upon selection of the graphical control element.

Example 33 may include the method of example 32 and/or some other examples herein, wherein the notification is one or more of another instance of the graphical user interface, a pop-up graphical user interface, a local push notification, a remote push notification, an audio output, or a haptic feedback output.

Example 34 may include the method of example 26 and/or some other examples herein, further comprising: obtaining, by the computer device, location data from positioning circuitry of the computer device or from modem circuitry of the computer device; obtaining, by the computer device, sensor data from one or more sensors of the computer device; obtaining, by the computer device, application data from one or more applications implemented by a host platform of the computer device; and determining, by the computer device, one or more contextual factors based on one or more of the location data, the sensor data, and the application data; and identifying, by the computer device, the plurality of states based on the one or more contextual factors.

Example 35 may include the method of example 34 and/or some other examples herein, wherein the one or more contextual factors comprise one or more of an amount of time that the computer device is at a particular location, an arrival time at a particular location, a departure time from a particular location, a distance traveled between two or more locations, a travel velocity of the computer device, position and orientation changes of the computer device, media settings of the computer device, information contained in one or more messages sent by the computer device, information contained in one or more messages received by the computer device, and an environment in which the computer device is located.

Example 36 may include the method of examples 26-35 and/or some other examples herein, wherein the computer device is implemented in a wearable computer device, a smartphone, a tablet, a laptop, a desktop personal computer, a head-mounted display device, a head-up display device, or a motion sensing input device.

Example 37 may include one or more computer-readable media including instructions, which when executed by one or more processors of a computer device, causes the computer device to perform the method of examples 26-36 and/or some other examples herein. In embodiments, the one or more computer-readable media may be non-transitory computer-readable media.

Example 38 may include a computer device comprising: state management means for determining various states of the computer device; intent management means for determining various user intents associated with the various states; and interface generation means for determining various semantic time anchors based on the various states, wherein each semantic time anchor of the various semantic time anchors corresponds to a state of the various states, and for generating one or more instances of the graphical user interface comprising various objects and the various semantic time anchors, wherein each object of the various objects corresponds to a user intent of the various user intents.

Example 39 may include the computer device of example 38 and/or some other examples herein, wherein each state comprises one or more of a location of the computer device, a travel velocity of the computer device, and a mode of operation of the computer device.

Example 40 may include the computer device of example 38 and/or some other examples herein, wherein the interface generation means is further for generating another instance of the graphical user interface to indicate a new association of a selected object with a selected semantic time anchor.

Example 41 may include the computer device of example 40 and/or some other examples herein, further comprising: input/output (I/O) means for obtaining a selection of the selected object through the graphical user interface, and for providing the one or more instances of the graphical user interface for display.

Example 42 may include the computer device of example 41 and/or some other examples herein, wherein: the selection of the selected object comprises a tap-and-hold gesture when the I/O means obtains the selection through a touchscreen or comprises a point-and-click when the I/O means obtains the selection through a pointer device, and the selection of the selected semantic time anchor comprises release of the selected object at or near the selected semantic time anchor.

Example 43 may include the computer device of example 41 and/or some other examples herein, wherein the interface generation means is further for visually distinguishing a semantic time anchor when the selected object is dragged at or near the semantic time anchor prior to the release of the selected object.

Example 44 may include the computer device of examples 40-42 and/or some other examples herein, wherein the interface generation means is further for: determining various new semantic time anchors based on an association of the selected object with the selected semantic time anchor; and generating another instance of the graphical user interface to indicate the selection of the selected semantic time anchor and the various new semantic time anchors.

Example 45 may include the computer device of example 43 and/or some other examples herein, wherein: the intent management means is further for determining various new user intents based on the selected semantic time anchor; and the interface generation means is further for generating various new objects corresponding to the various new user intents, and generate another instance of the graphical user interface to indicate the various new objects and only new semantic time anchors of the various new semantic time anchors associated with the various new user intents.

Example 46 may include the computer device of examples 38-44 and/or some other examples herein, wherein: the state management means is further for determining a current state of the computer device; the intent management means is further for identifying individual user intents associated with the current state; and the interface generation means is further for generating a notification to indicate the individual user intents associated with the current state.

Example 47 may include the computer device of example 46 and/or some other examples herein, wherein the notification is one or more of another instance of the graphical user interface, a pop-up graphical user interface, a local push notification, a remote push notification, an audio output, or a haptic feedback output.

Example 48 may include the computer device of examples 46-47 and/or some other examples herein, wherein the notification comprises a graphical control element to, upon selection of the graphical control element, control execution of an application associated with the individual user intents.

Example 49 may include the computer device of example 38 and/or some other examples herein, wherein, to determine the various states, the state management means is further for: obtaining location data from positioning circuitry of the computer device or from modem circuitry of the computer device; obtaining sensor data from one or more sensors of the computer device; obtaining application data from one or more applications implemented by a host platform of the computer device; and determining one or more contextual factors associated with each of the various states based on one or more of the location data, the sensor data, and the application data.

Example 50 may include the computer device of example 49 and/or some other examples herein, wherein the one or more contextual factors comprise one or more of an amount of time that the computer device is at a particular location, an arrival time at a particular location, a departure time from a particular location, a distance traveled between two or more locations, a travel velocity of the computer device, position and orientation changes of the computer device, media settings of the computer device, information contained in one or more messages sent by the computer device, information contained in one or more messages received by the computer device, and an environment in which the computer device is located.

Example 51 may include the computer device of examples 38-50 and/or some other examples herein, wherein the computer device is implemented in a wearable computer device, a smartphone, a tablet, a laptop, a desktop personal computer, a head-mounted display device, a head-up display device, or a motion sensing input device.

Example 52 may include a computer device comprising: state management means for determining a plurality of states; intent management means for determining a plurality of user intents; and interface generation means for: generating a first instance of an graphical user interface comprising a plurality of objects and a plurality of semantic time anchors, wherein each object of the plurality of objects corresponds to a user intent of a plurality of user intents, and each semantic time anchor is associated with a state of the plurality of states; obtaining a first input comprising a selection of an object of the plurality of objects; obtaining a second input comprising a selection of a semantic time anchor of the plurality of semantic time anchors; generating a second instance of the graphical user interface to indicate a coupling of the selected object with the selected semantic time anchor; and generating a notification to indicate a user intent of the selected object upon occurrence of a state that corresponds with the selected semantic time anchor.

Example 53 may include the computer device of example 52 and/or some other examples herein, wherein the plurality of states comprise a location of the computer device, a time of day, a date, a travel velocity of the computer device, and a mode of operation of the computer device.

Example 54 may include the computer device of example 52 and/or some other examples herein, further comprising input/output (I/O) means for obtaining the first and second input, and for providing the first and second input to the interface generation means, and wherein: the selection of the selected object comprises a tap-and-hold gesture when the I/O means obtains the selection through a touchscreen or comprises a point-and-click when the I/O means obtains the selection through a pointer device, and the selection of the selected semantic time anchor comprises release of the selected object at or near the selected semantic time anchor.

Example 55 may include the computer device of example 54 and/or some other examples herein, wherein the interface generating means is further for: visually distinguishing the selected semantic time anchor when the selected object is dragged at or near the selected semantic time anchor and prior to the release of the selected object.

Example 56 may include the computer device of examples 54-55 and/or some other examples herein, wherein the interface generation means is further for: determining a plurality of new semantic time anchors based on the selected semantic time anchor; and generating the second instance of the graphical user interface to indicate the plurality of new semantic time anchors.

Example 57 may include the computer device of example 56 and/or some other examples herein, wherein the interface generation means is further for: determining a plurality of new user intents based on the selected semantic time anchor; generating a plurality of new objects corresponding to the plurality of new user intents; and generating the second instance of the graphical user interface to indicate the plurality of new objects.

Example 58 may include the computer device of examples 52-57 and/or some other examples herein, wherein the notification comprises a graphical control element, and the interface generation means is further for: controlling, in response to selection of the graphical control element, execution of an application associated with the user intent indicated by the notification.

Example 59 may include the computer device of example 58 and/or some other examples herein, wherein the notification is one or more of another instance of the graphical user interface, a pop-up graphical user interface, a local push notification, a remote push notification, an audio output, or a haptic feedback output.

Example 60 may include the computer device of example 52 and/or some other examples herein, wherein the state management means is further for: obtaining location data from positioning circuitry of the computer device or from modem circuitry of the computer device; obtaining sensor data from one or more sensors of the computer device; obtaining application data from one or more applications implemented by a host platform of the computer device; determine one or more contextual factors based on one or more of the location data, the sensor data, and the application data; and determine the plurality of states based on the one or more contextual factors.

Example 61 may include the computer device of example 60 and/or some other examples herein, wherein the one or more contextual factors comprise one or more of an amount of time that the computer device is at a particular location, an arrival time at a particular location, a departure time from a particular location, a distance traveled between two or more locations, a travel velocity of the computer device, position and orientation changes of the computer device, media settings of the computer device, information contained in one or more messages sent by the computer device, information contained in one or more messages received by the computer device, and an environment in which the computer device is located.

Example 62. The computer device of any one of examples 52-61 and/or some other examples herein, wherein the computer device is implemented in a wearable computer device, a smartphone, a tablet, a laptop, a desktop personal computer, a head-mounted display device, a head-up display device, or a motion sensing input device.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, limited only by the claims.

1. A computer device comprising:
a state manager to be operated by one or more processors, the state manager to determine various states of the computer device;
an intent manager to be operated by the one or more processors, the intent manager to determine various user intents associated with the various states; and
an interface engine to be operated by the one or more processors, the interface engine to generate instances of a graphical user interface of the computer device, wherein to generate the instances, the interface engine is to:
determine various semantic time anchors based on the various states, wherein each semantic time anchor of the various semantic time anchors corresponds to a state of the various states, and
generate an instance of the graphical user interface comprising various objects and the various semantic time anchors, wherein each object of the various objects corresponds to a user intent of the various user intents.

2. The computer device of claim 1, wherein each state comprises one or more of a location of the computer device, a travel velocity of the computer device, and a mode of operation of the computer device.

3. The computer device of claim 1, wherein the interface engine is to generate another instance of the graphical user interface to indicate a new association of a selected object with a selected semantic time anchor.

4. The computer device of claim 3, further comprising:
an input/output (I/O) device to facilitate a selection of the selected object through the graphical user interface, wherein:
selection of the selected object comprises a tap-and-hold gesture when the I/O device comprises a touchscreen device or a point-and-click when the I/O device comprises a pointer device, and
selection of the selected semantic time anchor comprises release of the selected object at or near the selected semantic time anchor.

5. The computer device of claim 4, wherein the interface engine is to highlight a semantic time anchor when the selected object is dragged towards the semantic time anchor prior to the release of the selected object.

6. The computer device of claim 3, wherein the interface engine is to:
determine various new semantic time anchors based on an association of the selected object with the selected semantic time anchor; and
generate another instance of the graphical user interface to indicate the selection of the selected semantic time anchor and the various new semantic time anchors.

7. The computer device of claim 6, wherein:
the intent manager is to determine various new user intents based on the selected semantic time anchor; and
the interface engine is to generate various new objects corresponding to the various new user intents, and generate another instance of the graphical user interface to indicate the various new objects and only new semantic time anchors of the various new semantic time anchors associated with the various new user intents.

8. The computer device of claim 1, wherein:
the state manager is to determine a current state of the computer device;
the intent manager is to identify individual user intents associated with the current state; and
the interface engine to generate a notification to indicate the individual user intents associated with the current state.

9. The computer device of claim 8, wherein the notification comprises a graphical control element to, upon selection of the graphical control element, control execution of an application associated with the individual user intents.

10. The computer device of claim 1, wherein, to determine the various states, the state manager is to:
obtain location data from positioning circuitry of the computer device or from modem circuitry of the computer device;
obtain sensor data from one or more sensors of the computer device;
obtain application data from one or more applications implemented by a host platform of the computer device; and
determine one or more contextual factors associated with each of the various states based on one or more of the location data, the sensor data, and the application data.

11. The computer device of claim 10, wherein the one or more contextual factors comprise one or more of an amount of time that the computer device is at a particular location, an arrival time at a particular location, a departure time from a particular location, a distance traveled between two or more locations, a travel velocity of the computer device, position and orientation changes of the computer device, media settings of the computer device, information contained in one or more messages sent by the computer device, information contained in one or more messages received by the computer device, and an environment in which the computer device is located.

12. The computer device of claim 1, wherein the computer device is implemented in a wearable computer device, a smartphone, a tablet, a laptop, a desktop personal computer, a head-mounted display device, a head-up display device, or a motion sensing input device.

13. One or more computer-readable media including instructions, which when executed by a computer device, causes the computer device to:
determine a plurality of states and a plurality of user intents;
generate a first instance of a graphical user interface comprising a plurality of objects and a plurality of semantic time anchors, wherein each object of the plurality of objects corresponds to a user intent of a plurality of user intents, and each semantic time anchor is associated with a state of the plurality of states;
obtain a first input comprising a selection of an object of the plurality of objects;
obtain a second input comprising a selection of a semantic time anchor of the plurality of semantic time anchors;
generate a second instance of the graphical user interface to indicate a coupling of the selected object with the selected semantic time anchor; and
generate a notification to indicate a user intent of the selected object upon occurrence of a state that corresponds with the selected semantic time anchor.

14. The one or more computer-readable media of claim 13, wherein the plurality of states comprise a location of the computer device, a time of day, a date, a travel velocity of the computer device, and a mode of operation of the computer device.

15. The one or more computer-readable media of claim 13, wherein the instructions, when executed by the computer device, causes the computer device to:
visually distinguish the selected semantic time anchor when the selected object is dragged over the selected semantic time anchor and prior to the release of the selected object.

16. The one or more computer-readable media of claim 13, wherein the instructions, when executed by the computer device, causes the computer device to:
determine a plurality of new semantic time anchors based on the selected semantic time anchor; and
generate the second instance of the graphical user interface to indicate the plurality of new semantic time anchors.

17. The one or more computer-readable media of claim 16, wherein the instructions, when executed by the computer device, causes the computer device to:
determine a plurality of new user intents based on the selected semantic time anchor;
generate a plurality of new objects corresponding to the plurality of new user intents; and
generate the second instance of the graphical user interface to indicate the plurality of new objects.

18. The one or more computer-readable media of claim 13, wherein the notification comprises a graphical control element, and upon selection of the graphical control element, the instructions, when executed by the computer device, causes the computer device to:
control execution of an application associated with the user intent indicated by the notification.

19. A method to be performed by a computer device, the method comprising:
identifying, by a computer device, a plurality of user states and a plurality of user intents;
determining, by the computer device, a plurality of semantic time anchors, wherein each semantic time anchor of the plurality of semantic time anchors corresponds with a state of the plurality of states;
generating, by the computer device, a plurality of intent objects, wherein each intent object corresponds with a user intent of the plurality of user intents;
generating, by the computer device, a first instance of a graphical user interface comprising a timeline and an intents menu, wherein the timeline includes the plurality of semantic time anchors and the intents menu includes the plurality of plurality of intent objects;
obtaining, by the computer device, a first input comprising a selection of an intent object from the intents menu;
obtaining, by the computer device, a second input comprising a selection of a semantic time anchor in the timeline;
generating, by the computer device, a second instance of the graphical user interface to indicate an association of the selected intent object with the selected semantic time anchor; and
generating, by the computer device, a notification to indicate a user intent associated with the selected intent object upon occurrence of a state associated with the selected semantic time anchor.

20. The method of claim 19, wherein the plurality of user states comprise a location of the computer device, a time of day, a date, a travel velocity of the computer device, and a mode of operation of the computer device.

21. The method of claim 19, wherein:
the first input comprises a tap-and-hold gesture when an input/output (I/O) device of the computer device comprises a touchscreen device or the first input comprises a point-and-click when the I/O device comprises a pointer device, and
the second input comprises release of the selected object over the selected semantic time anchor.

22. The method of claim 19, wherein generating the second instance of the graphical user interface comprises:
generating, by the computer device, the selected semantic time anchor to be visually distinguish from non-selected semantic time anchors when the selected object is dragged to the selected semantic time anchor and prior to the release of the selected object.

23. The method of claim 19, wherein generating the second instance of the graphical user interface comprises:
determining, by the computer device, a plurality of new semantic time anchors based on the selected semantic time anchor; and
generating, by the computer device, the second instance of the graphical user interface to indicate the plurality of new semantic time anchors.

24. The method of claim 23, wherein generating the second instance of the graphical user interface comprises:
determining, by the computer device, a plurality of new user intents based on the selected semantic time anchor;
generating, by the computer device, a plurality of new intent objects corresponding to the plurality of new user intents; and
generating, by the computer device, the second instance of the graphical user interface to indicate the plurality of new intent objects.

25. The method of claim 19, wherein the notification comprises a graphical control element, and the method further comprises:
detecting, by the computer device, a current state of the computer device;
issuing, by the computer device, the notification when the current state matches the state associated with the selected semantic time anchor; and
executing, by the computer device, an application associated with the user intent indicated by the notification upon selection of the graphical control element.
